(19) United States
(12) Patent Application Publication
(10) Pub. No.: US 2021/0363651 A1
(43) Pub. Date: Nov. 25, 2021

(54) MULTI-STAGE DC POWER DISTRIBUTION SYSTEM

(71) Applicant: AquaHydrex, Inc., Louisville, CO (US)

(72) Inventors: Eric Seymour, Fort Collins, CO (US); Gerhard Frederick Swiegers, North Wollongong (AU)

(21) Appl. No.: 17/253,456

(22) PCT Filed: Jun. 20, 2019
(86) PCT No.: PCT/US2019/038299

§ 371 Date: Dec. 17, 2020

Related U.S. Application Data
(60) Provisional application No. 62/687,788, filed on Jun. 20, 2018.
(60) Provisional application No. 62/799,522, filed on Jan. 31, 2019.

(51) Int. Cl. C25B 9/65; C25B 9/77; C25B 9/19; C25B 15/023; C25B 1/04; H02J 1/08; H02J 1/10; H02J 3/18; H02J 3/38; H02M 3/158; H02M 7/219

(52) U.S. Cl. CPC C25B 9/65; C25B 9/77; C25B 9/19; C25B 15/023; C25B 1/04; H02J 1/08; H02J 15/008; H02J 3/18; H02J 3/381; H02M 3/1582; H02M 7/219; H02J 2300/24; H02J 2300/28; H02J 1/102

(57) ABSTRACT

DC power distribution systems and corresponding methods are disclosed herein. One method includes performing a first voltage conversion using an active rectifier to convert a first input AC voltage to a first output DC voltage and supplying the first output DC voltage from the active rectifier to a DC bus. The first output DC voltage from the DC bus is provided to a second input at a bucking cell-stack regulator, and a second voltage conversion, from the second input DC voltage to a second output DC voltage, is performed using the bucking cell-stack regulator. The second output DC voltage is applied to a DC load.

### TECHNICAL FIELD

The present invention relates to DC power distribution systems, electrosynthetic cells, modules or reactors used to synthesize products, and power supplies that provide power to the same.

### BACKGROUND

Industrial electrosynthetic cells (referred to generally herein as cells or cell stacks) are used to manufacture a variety of products by the consumption of electrical power. There are many examples of cells, but cells that are increasing in prospective value include hydrogen cells.

Hydrogen in molecular form (H₂) has been a valuable commodity for many decades. Uses typically include ammonia production, catalytic cracking of hydrocarbons and other industrial applications.

It has been recognized that hydrogen can serve as an energy-storage medium and will play a role in the future energy economy. One expected method for use of hydrogen in this application is through injection into the natural gas grid where enormous energy storage capacity is already available. This application is called Power to Gas (P2G). As P2G technology proliferates, electric power consumed by electrolyzers will increase.

A common feature of such cells is that they often require the application of direct current (also called DC). But electrical power is typically supplied by electrical utilities in the form of alternating current (also called AC). For such cells to operate utilizing AC power, a power supply that converts AC to DC is therefore needed.

At the present time, the most widely used AC-to-DC conversion process in power supplies for electrosynthetic cells is based on rectifier technology, specifically thyristors, combined with suitable transformers. Thyristor-transformer combinations in power supplies utilize a principle known as “current source conversion,” which is based on regulation of voltage during the conversion.

### SUMMARY

This Summary is provided to introduce a selection of concepts in a simplified form that are further described below in the Examples. This Summary is not intended to identify all of the possible features of the claimed subject matter, nor is it intended to be used to limit the scope of the claimed subject matter.

Some aspects provide a power supply and/or an electrosynthetic cell, or a combination thereof, for example to convert grid-supplied AC voltage to DC voltage for use by the electrosynthetic cell (or module or reactor).

Some aspects also provide a method of powering an electrosynthetic cell using a power supply, for example that converts grid-supplied AC voltage to DC voltage for use by the electrosynthetic cell (or module or reactor).

Some aspects provide a power supply for an electrosynthetic cell requiring DC power or voltage, the power supply utilizing voltage source conversion of AC power or voltage from a grid-or similar interface, to DC power or voltage.

Some aspects also provide a power supply and electrosynthetic cell in combination, wherein the power supply is configured to perform voltage conversion from an input AC voltage to an output DC voltage, and wherein the output DC voltage is supplied as an input power source for the electrosynthetic cell. The electrosynthetic cell, when supplied with the input power source, includes at least one cell stack that operates at an overall voltage greater than or equal to 500 V.

Some aspects provide a method of powering an electrosynthetic cell, comprising performing a voltage conversion, using a power supply, from an input AC voltage to an output DC voltage, and supplying the output DC voltage to the electrosynthetic cell as an input power source. The electrosynthetic cell, when supplied with the input power source, includes at least one cell stack that operates at an overall voltage greater than or equal to 500 V.

The voltage source conversion in some variations may be accomplished through use of an inverter, that is the power supply system can include an inverter.

The power supply may deliver electrical power in the form of an output DC voltage greater than or equal to 500 V. In variations, the power supply systems may supply a voltage greater than or equal to 900 V, greater than or equal to 1200 V, greater than or equal to 1500 V, greater than or equal to 2000 V, or, greater than or equal to 3000 V.

Some variations provide electrical power in the form of a current less than or equal to 3000 A. The currents may be less than or equal to 2000 A, less than or equal to 1500 A, less than or equal to 1200 A, less than or equal to 1000 A, less than or equal to 800 A, or, less than or equal to 500 A.

Some aspects provide a means of designing a cell stack or combined cell stacks of an electrosynthetic cell to accommodate a voltage source converter as the power supply.

In various implementations, the cell stack or combined cell stacks may utilize within each cell, liquid (e.g. liquid electrolyte) that is electrically isolated from the liquid (electrolyte) in the next or another cell within the stack or combined cell stacks during operation. If it is impossible for the liquid (electrolyte) in each cell to be electrically isolated from the liquid (electrolyte) in the next or another cell in the stack or combined cell stacks during operation, then the liquid (electrolyte) between the cells in question may be constrained to a narrow and long channel/pipe which reduces the parasitic current between the cells in question to less than 10% of the current during operation. In addition, the liquid electrolyte between the cells in question, may be constrained to a narrow and long channel/pipe which reduces the parasitic current between the cells to less than 5%, less than 3%, less than 2%, less than 1%, or less than 0.5% of the current during operation.

According to some aspects, the cell stack or combined cell stacks of the electrosynthetic cell is/are capable of, and designed to accommodate a voltage source converter as the power supply. That is, the cell stack or combined cell stacks of the electrosynthetic cell may be capable of, and designed to operate at a voltage greater than or equal to 500 V. For example, they may be capable of, and designed to operate at a voltage greater than or equal to 900 V, greater than or equal to 1200 V, greater than or equal to 1500 V, greater than or equal to 2000 V, or greater than or equal to 3000 V. The cell stack or combined cell stacks of the electrosynthetic cell may also be capable of, and designed to operate at a current less than or equal to 3000 A. The cell stack or combined cell stacks of the electrosynthetic cell may also be capable of, and designed to operate at a current less than or equal to 2000 A, less than or equal to 1500 A, less than or equal to 1200 A, less than or equal to 1000 A, less than or equal to 800 A, or, less than or equal to 500 A.

Another aspect may be characterized as a water electrolysis power supply system including at least one voltage-source active rectifier configured to provide power-quality services to an AC power grid that provides AC power at an input of the voltage-source active rectifier, and the voltage-source active rectifier is configured to provide voltage-regulated DC power at an output of the at least one voltage-source active rectifier. The system also includes a plurality of bucking cell-stack-regulators (CSRs), wherein each of the bucking cell-stack-regulators includes a DC input and a DC output, wherein the DC input to each of the bucking cell stack regulators is coupled to the voltage-regulated output of the voltage-source active rectifier, and wherein each of the bucking cell-stack-regulators is configured to regulate output current down to zero volts. In addition, the system includes a plurality of electrolysis cell stacks, wherein each of the electrolysis cell stacks is coupled to a corresponding one of the plurality of cell-stack regulators, and wherein each of the electrolysis cell stacks includes a plurality of electrolysis cells arranged in series.

Yet another aspect may be characterized as a water electrolysis power supply system that includes at least one voltage-source active rectifier configured to provide power-quality services to an AC power grid and to rectify AC power from the AC power grid to produce voltage-regulated DC power at an output of the at least one voltage-source active rectifier, wherein an output-capacitor is disposed across the output of the at least one voltage-source active rectifier. In addition, the system includes a plurality of bucking cell-stack-regulators (CSRs), and each of the bucking CSRs includes a DC input and a DC output, wherein an input-capacitor is disposed across the DC input of each of the bucking CSRs, and each of the bucking CSRs is configured to provide regulated current to the DC output, A plurality of dampers is also utilized in the system, and each of the dampers is disposed between the at least one voltage-source active rectifier and a corresponding one of the bucking cell-stack-regulators, each of the dampers is configured to damp ringing between the output capacitor of the voltage-source active rectifier and the input capacitor of the CSR. Each of a plurality of electrolysis cell stacks is coupled to a corresponding one of the plurality of cell-stack regulators, and wherein each of the electrolysis cell stacks includes a plurality of electrolysis cells arranged in series.

Another aspect may be characterized as a water electrolysis power supply system that includes at least one voltage-source active rectifier configured to provide power-quality services to an AC power grid and to apply voltage-regulated DC power at a DC bus by rectifying AC power from the AC power grid and a plurality of DC-to-DC regulators, wherein each of the DC-to-DC regulators is coupled to the voltage-source active rectifier, wherein at least one of the DC-to-DC regulators is configured to consume power from the DC bus to provide current to an electrolysis cell stack, and wherein at least another one of the CSRs is configured to draw power from a DC source (e.g., a PV array) and provide power to the DC bus. The system includes a coordinated controller that is coupled to the at least one voltage-source active rectifier and the plurality of DC-to-DC regulators, wherein the coordinated controller is configured to, in response to an event signal that indicates an event has affected the AC power, prompt the at least one voltage-source active rectifier to apply volt-ampere reactive (VAR) power (e.g., phased zero-degrees-leading reactive power, or other leading or lagging reactive power) to the input of the voltage-source active rectifier and trigger the plurality of DC-to-DC regulators to cease operating.

Another aspect is a water electrolysis power supply system that includes at least one voltage-source active rectifier including a rectifier-controller and switches, wherein the switches are controlled by the rectifier-controller to actively convert AC power at an input of the voltage-source active rectifier to provide boosted and voltage-regulated DC power at an output of the at least one voltage-source active rectifier. At least one voltage sensor coupled to the output of the voltage-source active rectifier to provide a voltage signal to the rectifier-controller to enable the rectifier-controller to regulate the boosted and voltage-regulated DC power, and a plurality of bucking cell-stack-regulators (CSRs) are included.

Each of the bucking cell-stack-regulators includes a DC input and a DC output, and the DC input to each of the bucking cell stack regulators is coupled to the voltage-regulated output of the voltage-source active rectifier. Each of the bucking cell-stack-regulators includes a CSR controller and at least one DC-to-DC-conversion-switch, wherein the CSR controller controls the at least one DC-to-DC-conversion-switch to provide regulated current to the DC output. A plurality of dampers are also utilized, and each of the dampers is disposed between the at least one voltage-source active rectifier and a corresponding one of the bucking cell-stack-regulators. Each of the plurality of dampers including inductive, capacitive, and resistive elements to damp oscillations between the at least one voltage-source active rectifier and the corresponding one of the bucking cell-stack-regulators.

Each of a plurality of current transducers are disposed to sense current at a corresponding one of the DC outputs of the cell-stack-regulators, and each of the current transducers is coupled to a corresponding one of the CSR controllers to provide a signal indicative of the current at the corresponding one of the DC outputs. Each of a plurality of electrolysis cell stacks are included, and each of the electrolysis cell stacks is coupled to a corresponding one of the plurality of cell-stack regulators. A coordinated controller is coupled to the at least one voltage-source active rectifier and the plurality of bucking cell-stack-regulators. The coordinated controller is configured to, in response to an event signal that indicates an event has affected the AC power, prompt the at least one voltage-source active rectifier to apply volt-ampere reactive (VAR) power to the input of the voltage-source active rectifier and trigger the plurality of bucking cell-stack-regulators to cease providing the regulated current to the plurality of electrolysis cell stacks.

For the purpose of clarity, the term “during operation” refers to the situation where the cell stack or combined cell stacks of the electrosynthetic cell operate at a voltage greater than or equal to 500 V, or greater than or equal to 900 V, greater than or equal to 1200 V, greater than or equal to 1500 V, greater than or equal to 2000 V, or, greater than or equal to 3000 V.

### BRIEF DESCRIPTION OF THE DRAWINGS

FIG. 1 is an illustration of a utility scale DC power and electrolyzer system;

FIG. 2A is a block diagram depicting aspects of an exemplary implementation of the DC power and electrolyzer system of FIG. 1;

FIG. 2B is a block diagram depicting aspects of another exemplary implementation of the DC power and electrolyzer system of FIG. 1;

FIG. 2C is a flowchart depicting a method that may be traversed in connection with the embodiment depicted in FIG. 2B;

FIG. 3 is a schematic diagram depicting aspects of yet another exemplary implementation of the DC power and electrolyzer system of FIG. 1;

FIG. 4 is a schematic diagram illustrating aspects that may be implemented at a photovoltaic power facility;

FIG. 5A is schematic diagram depicting an exemplary voltage-source active rectifier that may be utilized to realize the active rectifiers disclosed herein;

FIG. 5B depicts a single phase one-line diagram of various potential designs for a voltage-source active rectifier;

FIG. 6 is a schematic diagram illustrating an exemplary damper;

FIG. 7 is a schematic diagram illustrating an exemplary cell stack regulator;

FIG. 8A is a block diagram depicting an exemplary DC holdup component;

FIG. 8B is a block diagram depicting another exemplary implementation of a DC holdup component;

FIG. 9 is a schematic drawing depicting exemplary grounding locations in a cell stack power distribution system;

FIG. 10 is a schematic representation of a ground-path filter system;

FIG. 11 is a cutaway view of an example cell stack; and

FIG. 12 is a block diagram depicting physical components that may be utilized to realize aspects of embodiments disclosed herein,

### DETAILED DESCRIPTION

The following modes, features or aspects, given by way of example only, are described in order to provide a more precise understanding of the subject matter of several embodiments.

The reference in this specification to any prior publication (or information derived from it), or to any matter which is known, is not an acknowledgment or admission or any form of suggestion that the prior publication (or information derived from it) or known matter is conventional, routine, or forms part of the common general knowledge in the field of endeavour to which this specification relates.

The word “exemplary” is used herein to mean “serving as an example, instance, or illustration.” Any embodiment described herein as “exemplary” is not necessarily to be construed as preferred or advantageous over other embodiments.

### Introduction to Large Scale DC Power and Electrolyzer Implementations

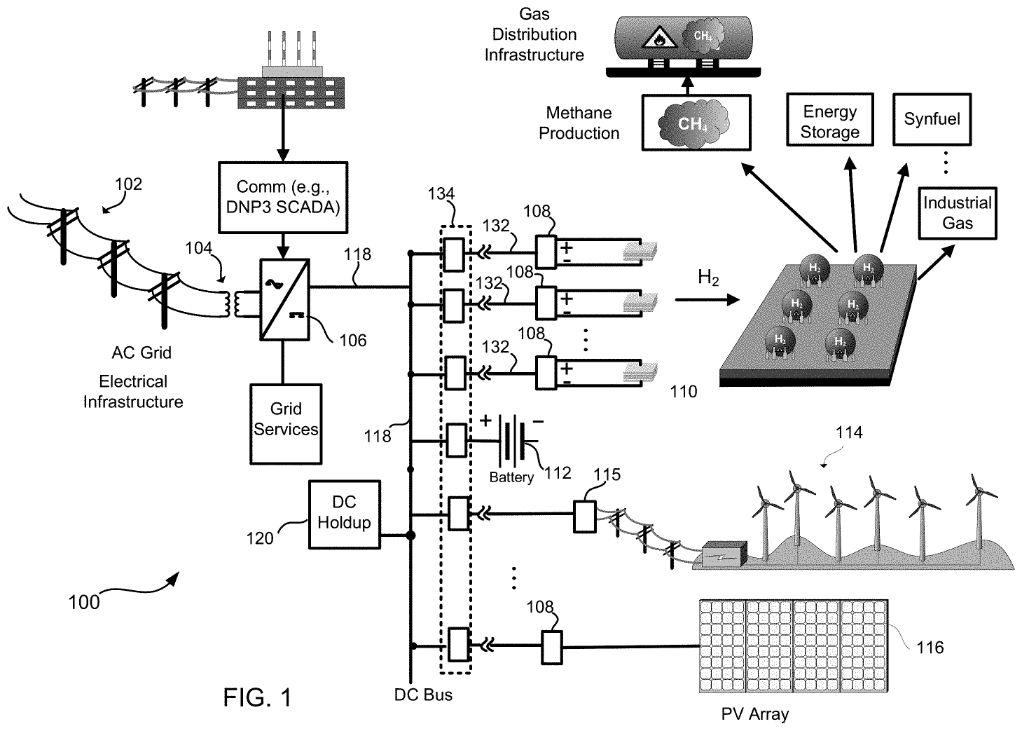

Referring to FIG. 1, shown is a utility scale DC power and electrolyzer system 100 that includes several inventive aspects. An aspect of the DC power and Electrolyzer system 100 is that it enables interoperation with a power utility's grid 102, variable and intermittent energy sources, and commodity (e.g., hydrogen, natural gas, or other chemical) distribution systems. The large scale of the DC power and Electrolyzer system 100 and its connection to the AC utility grid gives rise to several technological problems, to which the present disclosure provides solutions.

In particular, Applicants anticipate that electrical grid utility operators will begin to require operators of large-scale electrolyzers to mitigate power quality problems commonly introduced by conventional power conversion systems currently used by the industry. The systems and methods described herein provide for efficient conversion of grid-supplied AC power for use in large-scale electrolyzer systems while simultaneously mitigating power quality problems and providing the ability to offer ancillary services for improving power quality on the grid.

But before the constituent components (and interoperation of the constituent components) are discussed in detail, it is helpful to understand aspects of technologies that (although related to the components depicted in FIG. 1) are deficient or otherwise unsatisfactory for implementation in the context of the depicted DC power and electrolyzer system 100. Although the following related technologies (and their associated deficiencies) are known to Applicant, Applicant does not assert that the following technologies and their associated problems are conventional, routine, well known, or even recognized in the prior art. In fact, many of the technologies and problems described below are apparently not recognized or understood by those skilled in the art as evidenced by conventional technical approaches to power conversion in the field of electrosynthetic cells and electrolyzer systems.

As used herein, a “DC” waveform, applicable to either voltage or current, includes a constant, unvarying component to which a possible oscillating component or components may be added such that the overall waveform does not change sign during any oscillation. For example, a rectified direct current may be “positive” or “negative” depending on sign convention, often including considerable oscillatory components, but the waveform is considered to be DC as long as the waveform remains on the same side of zero. As used herein, the “DC value” of a waveform may refer to an instantaneous value, the averaged value, or the root-mean-square (RMS) value of the waveform. These values may be the same or differ for a given waveform, but are all generally referred to herein as DC values.

### Electrosynthetic Cells and Power Supplies

Electrosynthetic systems, otherwise referred to herein as “electrolyzers”, are generally collections of reaction cells in which electrochemical reactions are driven by the application of electrical power to the cells. Depending on the materials, currents, voltages, feedstocks, and other factors affecting the cells, various products may be produced from various feedstock or source materials.

Examples of electrosynthetic cells include those for electrochemically synthesizing products such as hydrogen, oxygen, hydrogen peroxide, fuels, chemicals or polymers, ozone, chlorine, caustic (with or without chlorine), potassium permanganate, chlorate, perchlorate, fluorine, bromine, persulfate, CO₂ and other products. Such chemicals or other products may be produced from feedstocks such as water (e.g., deionized water, untreated municipal water, treated or untreated seawater, etc.), natural gas, methane, air, carbon dioxide, oxygen, gas mixtures, or other liquid, solid, or gaseous feedstock materials. Electrosynthetic cells are also employed in: electrometallurgical applications, including but not limited to metal electrowinning, electrorefining, electroextraction, and/or electrodeposition, such as the manufacture of metals and metal-based materials including but not limited to: aluminium, cobalt, nickel, and others, as well as pulp and paper industry applications, including but not limited to: “black liquor” electrolysis, “Tall Oil recovery” and (iii) chloride removal electrolysis.

A common feature of such cells is that they often require the application of direct current (also called DC). However, electrical power is typically supplied by electrical utilities in the form of alternating current (also called AC). For such cells to operate from an AC power source, a power supply that converts AC to DC is therefore required.

At the present time, the most widely used AC-to-DC conversion process in power supplies for electrosynthetic cells is based on rectifier technology, specifically thyristors, combined with suitable transformers. Thyristor-transformer combinations in power supplies utilize a principle known as “current source conversion,” which is based on regulation of voltage during the conversion.

This process has a number of disadvantages, which include: (i) relatively high cost; (ii) the creation of harmonics that can locally pollute the electrical grid to which the power supply is attached; and (iii) relative inefficiency, especially in the presence of fluctuating AC currents of the type that may be produced by renewable energy sources such as wind, solar, or biomass. For example, thyristor/transformer-powered water electrolyzers driven by fluctuating wind power may see a significant decrease in their electrical efficiency when they are operated at 40% or less of their full capacity,

An example of an electrosynthetic cell is a water electrolyzer than utilizes electrical power to split water into hydrogen gas (at the negative electrode) and oxygen gas (at the positive electrode) at 60-90° C. At the present time, water electrolyzers are commercially available from a number of vendors, including HYDROGENICS, NEL, SIEMENS, MCPHY, AREVA, and others, Several commercially-available water electrolyzers utilize power supplies comprising thyristor-transformer combinations. There may be several reasons for this.

For example, in the case of alkaline electrolyzers, which utilize highly conducting liquid electrolytes like aqueous potassium hydroxide (KOH), the operation of the cell stack or combination of cell stacks may be typically limited by the conductivity of the electrolyte. That is, the parasitic losses that occur between cells having shared liquid electrolyte, increase as an approximately cubic function of the stack height. In other words, parasitic losses between cells having shared liquid electrolyte, grow cubically as the number of cells within the stack increases. Since each cell operates at a particular voltage (usually between 1.7-2.2 V), stack height is, effectively, a proxy for the overall voltage of operation, meaning that, as the overall voltage of operation of the stack increases, so do the proportion of the overall current characterised as parasitic currents. Accordingly, some alkaline electrolyzers may be limited to maximum stack heights of 50 cells (corresponding to 85-110 V), or less than 80 cells (corresponding to 136-176 V). Stack heights of 200 cells (corresponding to 187-242 V) or more may be unviable in a stack with electrolyte common to all cells because the proportion of unwanted parasitic currents to desired cell currents becomes unacceptable.

In the case of other classes of electrolyzer, there may be other reasons that power supplies comprising thyristor-transformer combinations are used. For example, polymer electrolyte membrane electrolysis PEM water electrolyzers utilize a solid-state electrolyte with non-conducting water so that parasitic currents are less of a limitation. However, the cells in such electrolyzers may typically operate at exceedingly high current densities (i.e., electric current per unit of planar area of the electrodes), meaning that their overall current becomes extremely high.

For example, many PEM electrolyzers operate at current densities of 1.7-2 A/cm². A cell within a stack or combination of stacks having a typical geometric area of 0.5 m² (=5000 cm²) will typically have 8,500-10,000 A of current passing through it. Since the cells in a PEM electrolyzer stack may typically be arranged in a bipolar (series) arrangement, the stack will also have 8,500-10,000 A of current passing through it. Conventionally, such a current is best generated from alternating current by a power supply comprising a thyristor-transformer combination, because thyristors are the only devices known to be capable of handling such currents. As a result, those skilled in the art have generally considered thyristor-transformer combinations to be the only viable technology for electrolyzer power supplies.

The anticipated emergent power to gas application has led water electrolyzer manufacturers to increase power ratings. It is often easier to increase the size of the cells while keeping the number of cells in a stack constant. This has led to an increase in the current ratings of the equipment that further re-enforces the existing preference for the high-current capabilities of thyristor-based rectifiers, also referred to as silicon controlled rectifiers (SCRs).

The operational characteristics of SCRs lead to the converters incorporating them being classified as current source converters (CSC). While well suited to a wide variety of loads, current source converters have long presented problems to the electrical grid.

Issues with CSCs include harmonic current injection, localized grid voltage notching and poor displacement power factor. Despite typically favorable treatment extended by electrical utilities to their customers, mitigation measures for these power quality problems may be mandated by utilities. These include: high pulse order rectifiers at higher power levels, power factor correction measures and tuned filters to absorb injected harmonic currents.

However, even including such traditional power quality mitigation measures, current source converters are predicted here to be an inadequate choice for power to gas applications. This is because a grid operator will likely consider a power to gas electrolysis system as a dispatchable load asset with a strong desire for additional ancillary services. Such services include dispatchable reactive power and numerous contingency response behaviors such as low-voltage ride-through (LVRT). CSCs are intrinsically incapable of performing any of these functions.

A different class of AC-to-DC converter, called a voltage source converter (VSC), can satisfy requirements conceivably imposed by a grid operator on a power facility. Unfortunately, this type of converter, also called an active rectifier (AR), is not well suited to running an electrolyzer for several reasons. First, an AR provides a DC voltage no lower than a pre-determined floor. That is, active rectifiers typically cannot deliver power with DC voltages approaching zero volts. Secondly, the devices used in VSCs are generally less well-suited to carrying high current than SCRs, Lastly, available VSCs operate at DC-side voltages significantly higher than the rating of traditional electrolysis stacks. For these reasons (among others), the use of VSCs in power supplies has been widely avoided by those in the electrolyzer industry.

What is needed is a system that combines the beneficial capabilities of both CSCs and VSCs in order to provide the ability to deliver ancillary services to electrical grid while efficiently and effectively providing power to an electrolyzer system.

### DC Power and Electrolyzer System

Referring again to FIG. 1, the DC power and electrolyzer system 100 is coupled to an AC grid 102 via a transformer 104 that is coupled to an active rectifier 106 of the DC power and electrolyzer system 100. The active rectifier 106 is coupled to a plurality of bucking cell-stack-regulators (CSRs) 108, wherein each of the cell-stack-regulators 108 includes a DC input and a DC output, and the DC input to each of the bucking cell stack regulators 108 is coupled to the voltage-regulated output of the voltage-source active rectifier 106.

As shown, the DC power and electrolyzer system 100 also includes a plurality of electrosynthetic cell stacks 110 (depicted as electrolysis cell stacks), which are each coupled to a corresponding one of the plurality of cell-stack regulators 108, and wherein each of the electrolysis cell stacks 110 includes a plurality of electrolysis cells arranged in series. As depicted in FIG. 1, each of the electrolysis cell stacks 110 may produce hydrogen that may be stored locally before being distributed via any of a variety of distribution channels, Also shown coupled to the active rectifier 106 are a battery 112, a windfarm 114 and a PV array 116.

In operation, power is sourced to the DC power and electrolyzer system 100 by the active rectifier 106. In addition to providing dispatchable reactive power to the AC grid 102, the active rectifier 106 typically regulates the voltage of a DC distribution bus 118. Alternative embodiments may use one or more additional DC bus resources configured to determine the bus voltage and to direct the active rectifier 106 to a power setpoint. As described further herein, the active rectifier 106 may be a rectifier that actively generates a sine wave with an amplitude and phase, relative to an amplitude and phase of the sine wave of the power of the AC grid 102, in order to interact the two sine waves (e.g., subtract them from one another) to generate the current and real, dispatchable, reactive power that is desired.

Although the depiction of components in FIG. 1 is not exactly to scale, FIG. 1 is intended to convey that the DC power and electrolyzer system 100 is a relatively large-scale system in terms of both power and dimensions. For example, electrical conductors of the DC bus 118 between the active rectifier 106 and each of the cell-stack regulators 108 comprise a transmission line which may traverse considerable distance within the facility, and as a result, exhibit non-trivial electrical resistance and inductance. As an example, the distance between the active rectifier 106 and each of the cell-stack regulators 108 may be 10, 20, 30, 40, or 50 meters or more, and in various implementations, the inductance of the transmission line(s) may be 500 nanohenrys (nH) per meter to 750 nH per meter or more. The electrical resistance of the transmission line(s) may be 700 microohms per meter or more.

Any number of DC-coupled resources may be connected to the DC bus 118. For example, the resources may be power-consuming resources such as the electrolysis cell stacks 110, batteries 112, flow batteries, pumps, compressors, flywheels, etc. In other examples, resources connected to the DC bus 118 may include power-generating or power-delivering resources such as photovoltaic arrays 116, solar thermal power generators, wind turbines 114, tidal or wave power generators, batteries 112, flywheels, etc.

In terms of power, the DC power and electrolyzer system 100 may be at least a 5 MW system, at least a 50 MW system, and it is contemplated that implementations may substantially exceed 100 MW. In general, it is contemplated that the desirability of grid ancillary services will be commensurate with the power-level of the system. So, it is likely (but not required) that DC power and electrolyzer systems exceeding 100 MW will include grid services capabilities.

As depicted, each of the DC-coupled resources may interface with the DC distribution bus 118 through a cell-stack regulator 108, which operates as a DC/DC converter. As described further herein, each of the cell-stack-regulators 108 may include a CSR controller to provide regulated current to the DC output 132 of each cell stack regulator 108.

As shown in FIG. 1, several resources may be connected to the DC distribution system, and it is contemplated that one or more of the resources may include a capacitor connected across the DC bus 118. For example, one or more capacitors establishing a capacitance of between 1 and 10 (or more) millifarad across the positive and negative conductors at the DC output of the active rectifier 106.

To avoid adverse resonance interaction with the transmission line inductance of the DC bus 118, one or more of the DC resources may include resonant dampers as further described below. Such dampers may include passive components connected in parallel and/or series with the DC bus 118. Alternatively, dampers may include active damping controls.

Also depicted in FIG. 1 is a DC holdup component 120. In operation, the DC holdup component 120 may operate to support the DC bus 118 at a minimum voltage when needed (e.g., during extreme grid disturbances). As discussed further herein, the DC holdup component 120 may be realized, at least in part, by an energy storage device or energy conversion device such as a battery, flow battery, fuel cell stack, turbine, flywheel, or other DC power source. Holding up a voltage of the DC bus 118 allows the active rectifier 106 to perform desired contingency behaviors when grid conditions do not permit the active rectifier 106 to regulate the DC bus 118.

One implementation of the DC holdup component 120 includes a backup battery which is diode-connected to the bus where the battery is configured to deliver a voltage slightly lower than the normal-condition DC distribution voltage. For example, the backup battery may be connected to the DC bus 118 in a manner that causes a voltage delivered by the battery to the DC bus 118 to be less than the normal-condition DC distribution voltage by a predetermined offset. In various embodiments, the offset may be between about 10 volts and about 50 volts. For example, the offset may be about 10 volts, 20 volts, 30 volts, 40 volts, or 50 volts, or more. In some embodiments, the offset may be at least 10 volts, at least 20 volts, at least 30 volts, at least 40 volts, or at least 50 volts.

The backup battery may be connected to the bus via one or more diodes (i.e., “diode-connected”) such that current may flow from the battery to the bus 118 in the event that the bus voltage falls below the offset battery voltage. Any suitable diodes may be used, such as high voltage power diodes or others. In some cases, the battery may be connected to the bus via other electronic components such as resistors, capacitors, etc.

A backup battery may be configured to deliver a voltage lower than the normal-condition DC distribution voltage. In some embodiments, a backup battery may be configured to deliver a voltage to the bus that is between about 10 volts and 30 volts (or more) lower than the DC bus voltage controlled by the active rectifier 106. In various embodiments, the backup battery voltage may be at least 10 volts, 20 volts, 30 volts, or more lower than the controlled DC bus voltage. Stated differently, a backup battery may be configured to deliver a voltage that is lower than the controlled DC bus voltage by about 1% to 4% or more of the controlled DC bus voltage (e.g., at least about 1%, 2%, 3%, 4% or more).

Other implementations may include one or more energy storage devices connected to the bus through a DC-to-DC converter, which may be actively or passively controlled to regulate the DC bus voltage.

One beneficial aspect of the two-stage power conversion architecture described herein (in which the active rectifier 106 is a first stage and the cell-stack regulators 108 are a second stage) is that the size of the active rectifier 106 is decoupled from the DC resources coupled to the DC bus 118. As a result, the size of the active rectifier 106 may be dictated by cost. That is, there need not be a fixed relationship between the size of the active rectifier 106 and the size of the cells stacks 110. It is contemplated that the active rectifier 106 may have a far greater power capacity (e.g., approaching an order of magnitude greater) than the power demand of the cell-stack regulators 108. So, for example, there may be 5, 6 or even 10 or more cell stack regulators 108 coupled to a single active rectifier 106 (as needed) to match the active rectifier's 106 size. This decoupling is particularly beneficial in view of the fact that, historically, the size of available inverters has grown, such that smaller inverter sizes that were commonly available a decade ago are now rare or unavailable in the market.

Similarly, multiple active rectifiers 106 may receive power from a single transformer 104, allowing for decoupling of the size (i.e., power capacity) of the transformer 104 and the active rectifiers 106. This decoupling enables separate cost optimization of transformers 104 and active rectifiers 106. In addition, such a configuration necessitates that the active rectifiers 106 place no special demand for added features in the transformer design (e.g. tertiary windings, electrostatic shields, special insulation systems, and/or specific leakage inductance) that would otherwise increase the cost and complexity of the transformer 104.

In addition, the DC power and electrolyzes system 100 may include one or more dampers 134 which may be disposed between the voltage-source active rectifier 106 and a corresponding one of the bucking cell-stack-regulators 108. Each of the plurality of dampers 134 may include inductive, capacitive, and/or resistive elements (described in more detail further herein) to damp oscillations between the at least one voltage-source active rectifier 106 and the corresponding one of the bucking cell-stack-regulators 108.

The system also includes a plurality of electrolysis cell stacks 110 (a single stack is shown for clarity), and each of the electrolysis cell stacks 110 is coupled to a corresponding one of the plurality of cell-stack regulators 108.

Another aspect of many of the DC distribution systems disclosed herein is that there is no need for the DC resources to be identical to one another in any qualitative or quantitative sense. For example, batteries, flywheels, DC power generation sources, and other DC load and/or source devices may be coupled to the DC bus. Several implementations of the active rectifier 106 and cell stack regulators are capable of bi-directional power flow; thus, readily applicable for devices that consume and/or dispatch power. Thus, the DC distribution system 100 may enable operation of a large scale electrolyzer facility that provides dispatchable reactive power support according to anticipated regulatory requirements.

The multi-stage aspect also enables providing clean and regulatable power to the electrolysis stacks 110 while providing grid services and desired grid interconnection behaviors. A single stage with an active rectifier 106 would not be capable of regulating its output DC voltage to very low voltages approaching 0 volts, because the active rectifiers 106 contemplated herein are limited to delivering a minimum voltage of hundreds of volts. However, the addition of a second stage made up of multiple cell stack regulators 108 enables the regulation of power delivered to cell stacks 110 from 0 volts up to a certain maximum.

Notably, this two-stage design is actually likely to be less efficient than prior approaches (e.g., rectifier approaches utilizing silicon-controlled rectifiers). For example, the active rectifier 106 is about 98% efficient at full power, and the cell stack regulators are about 99% efficient if the input and output voltages are relatively close to one another. That 3% inefficiency may be worse than that presently seen in the conventional class of electrochemical rectifiers. Nonetheless, Applicants have determined that the commercial and economic benefits offered by such a two-stage system may significantly outweigh the costs imposed by lower energy efficiency.

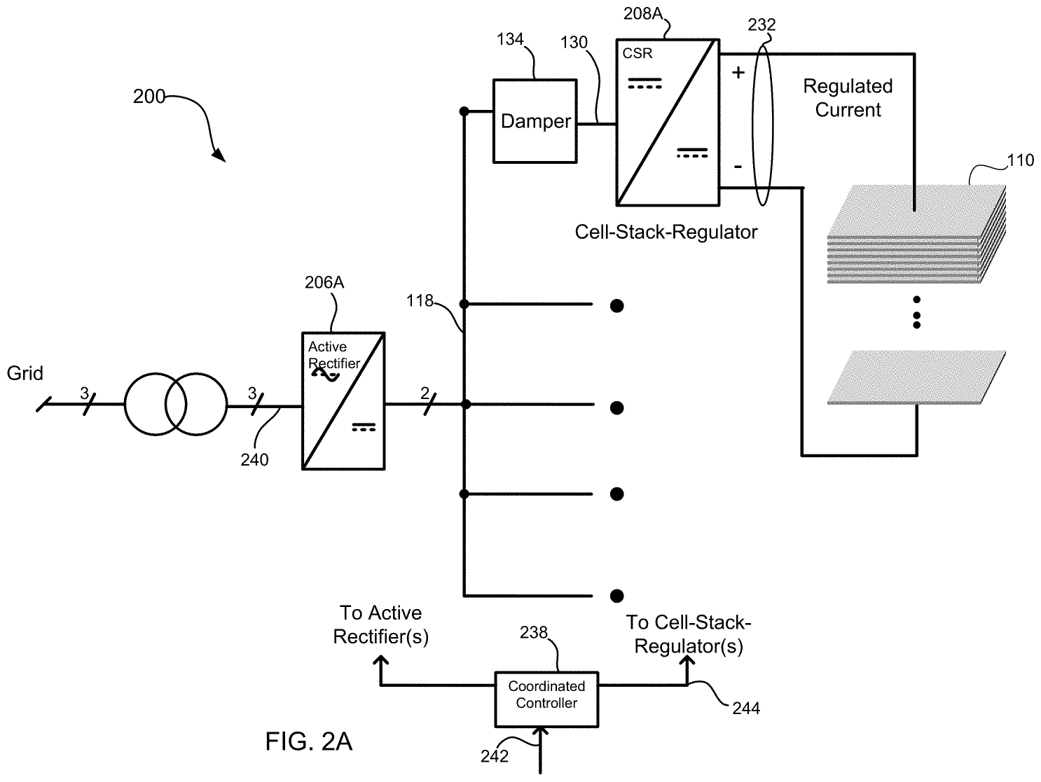

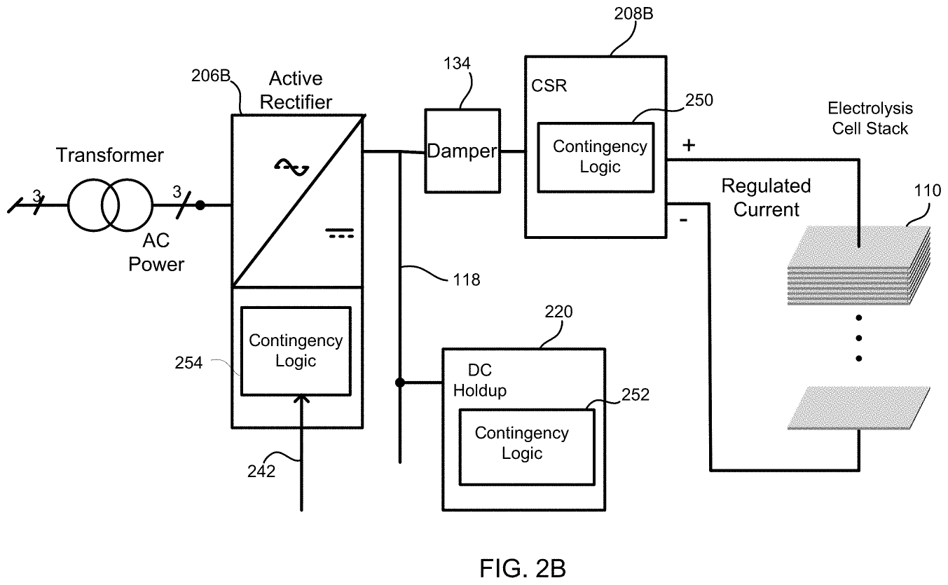

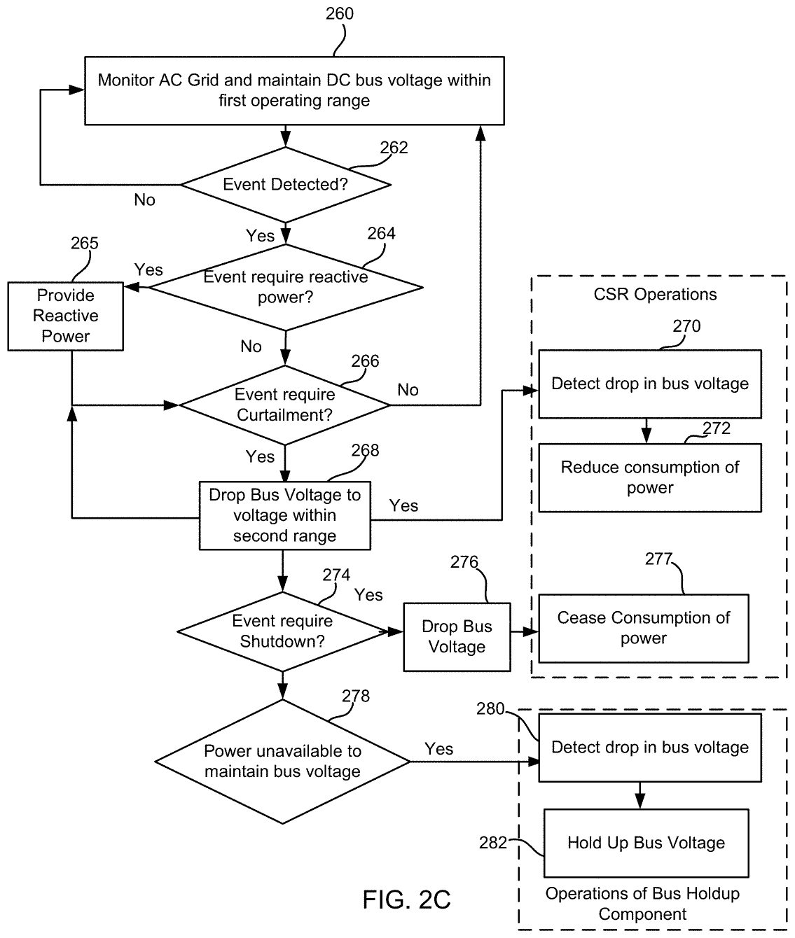

Referring next to FIG. 2A, shown are aspects of an exemplary DC power and electrolyzer system 200. In this system 200, at least one voltage-source active rectifier 206A actively converts AC power at an input of the voltage-source active rectifier 206A to provide boosted and voltage-regulated DC power to the DC distribution bus 118 at an output of the at least one voltage-source active rectifier 206A. Also shown are a plurality of bucking cell-stack-regulators (CSRs) 208A that include a DC input 130 and a DC output 132. The DC input 130 to each of the bucking cell stack regulators 208A is coupled to a voltage-regulated output of the voltage-source active rectifier 206A.

A coordinated controller 238 is coupled to the at least one voltage-source active rectifier 206A and the plurality of bucking cell-stack-regulators 208A powered by that active rectifier 206A. The coordinated controller 238 may be configured to, in response to an event signal 242 that indicates an event has affected the AC power, prompt the at least one voltage-source active rectifier 206A to apply volt-ampere reactive (VAR) power to the input side 240 (i.e., the AC side) of the voltage-source active rectifier 206A and trigger one or more of the plurality of bucking cell-stack-regulators 208A to cease providing the regulated current to one or more of the plurality of electrolysis cell stacks 110. The event signal 242 may be sent via a DNP3 SCADA communication link, but other types of communication links may be utilized. One or more of the plurality of the bucking cell-stack-regulators 208A may be triggered to cease providing the regulated current to the plurality of electrolysis cell stacks 110 by receiving one or more active control signals 244 that direct one or more of the cell stack regulators 208A to shut down, ramp-down, or otherwise stop delivery of power to one or more of the cell stacks 110. In some variations, one or more of the cell stack regulators 208A may be prevented from applying power to one or more of the cell stacks 110 by breaking one or more paths of conduction between the cell-stack regulators 208A and the cell stacks 110 (e.g., by causing one or more relay switches to open).

Referring next to FIG. 2B, shown is an embodiment in which one or more cell stack regulators 208B and DC holdup components 220 operate without a communication line from either the active rectifier 206B or the AC grid 102. As shown, a cell stack regulator 208B and DC holdup component 220 may each be implemented with contingency logic 250, 252 that enables the cell stack regulator 208B and the DC holdup component 220 to operate based upon aspects of the power applied to the DC bus 118 by the active rectifier 206B.

In some embodiments, the step of triggering the plurality of bucking cell-stack-regulators 208B to cease providing the regulated current to the plurality of electrolysis cell stacks 110 may simply comprise one or more of the plurality of bucking cell-stack-regulators 208B responding to a drop in the DC power applied by the voltage-source active rectifier 206B to the DC bus 118. For example, in some embodiments, CSR control logic 208B may be configured to monitor the DC bus voltage supplied by the voltage-source active rectifier 206B, and in response to detecting a decreased DC bus voltage, the CSR 208B may decrease power consumption by decreasing power delivered to a cell stack 110. In various embodiments, this decrease in CSR-delivered power may be linearly related to the detected DC bus voltage. Alternately, CSR-delivered power may be non-linearly (e.g., a stepped, geometric, or exponential function) related to detected DC bus voltage. In still further embodiments, combinations of linear and non-linear functions may be used. When DC bus voltage falls low enough, the CSR 208B will effectively deliver zero power to its corresponding cell stack 110.

In addition, the active rectifier 206B may also include contingency logic 254 to enable the active rectifier 206B to control the power applied to the DC bus 118 to effectuate operational changes in the cell stack regulator 208B and/or the DC holdup component 220 without a communication link (other than the DC bus 118). In some implementations, the contingency logic 254 of the active rectifier 206B is programmed to be coordinated with the contingency logic 250, 252 of both the cell stack regulator 208B and the DC holdup component 220 to enable coordinated control (of the cell stack regulator 208B and the DC holdup component 220) with only power control of the DC bus 118.

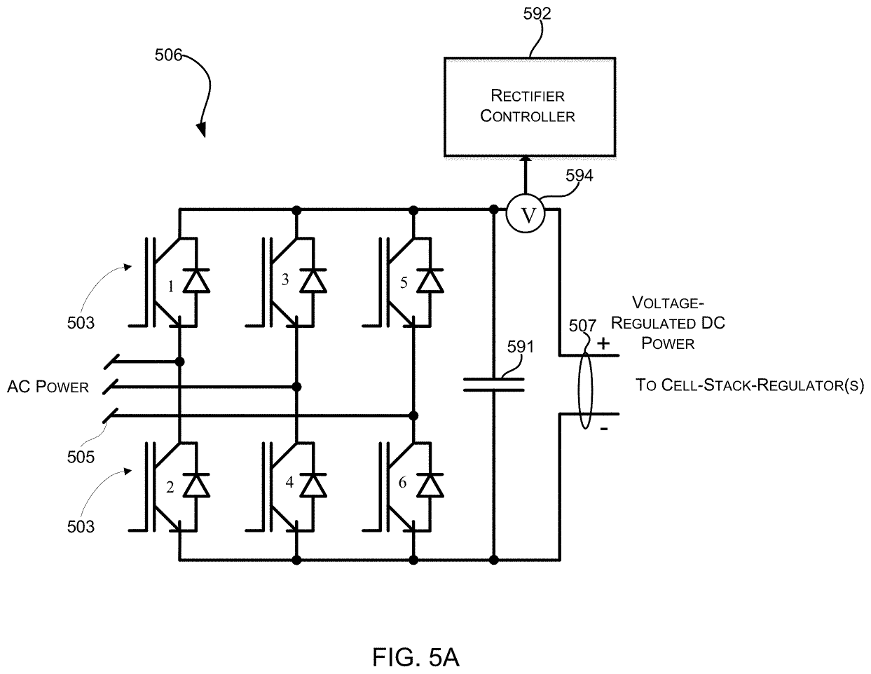

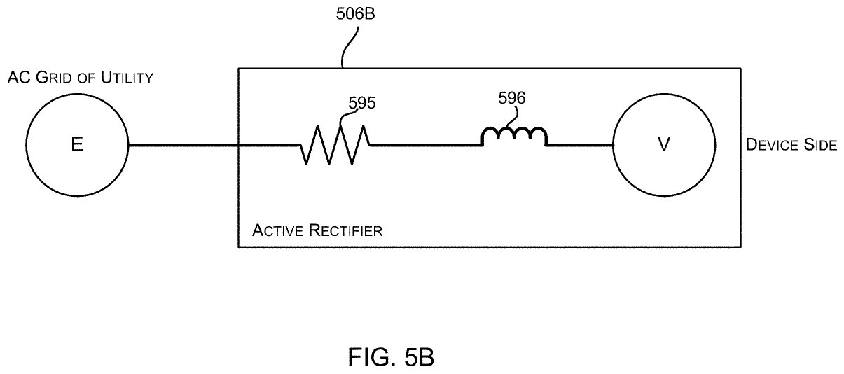

While referring to FIG. 2A and FIG. 2B, simultaneous reference is made to FIG. 2C, which is a flowchart depicting an exemplary method that may be traversed in connection with the embodiments depicted in FIG. 2A and FIG. 2B. In some embodiments, the process of FIG. 2C may be executed by two or more of the coordinated controller 238, the active rectifier controller 592 (discussed with reference to FIG. 5A), and one or more CSR controllers 7112 (discussed with reference to FIG. 7) acting in concert. In other embodiments, the process of FIG. 2C may be executed by the coordinated controller 238 or the active rectifier controller 592 individually.

As shown in FIG. 2C, in a typical mode of operation, the active rectifier monitors the AC grid 102 and maintains a DC bus voltage within a first operating range (Block 260). The typical mode of operation may be a bus voltage between 900 and 1000 VDC, but the range of voltages in the typical mode of operation may vary. The active rectifier may monitor the AC grid by either sensing aspects of the power on the AC grid and/or by receiving information via communication link (e.g., a DNP3 SCADA link or others) from an operator of the AC grid 102.

If an event is detected (Block 262) (e.g., a sudden decrease in the voltage of the AC power grid), and there is a demand for reactive power (Block 264), the active rectifier may apply the reactive power to the AC grid 102 (Block 265). And if the event requires curtailment (Block 266), the active rectifier may adjust the bus voltage from the typical voltage level to a second (typically lower) voltage range (Block 268). For example, the second voltage range may be between 820 and 900 VDC. In response, the cell stack regulator(s) will detect the change in bus voltage to the second range and reduce a consumption of power (Blocks 270 and 272).

If the event requires a shutdown (Block 274), the active rectifier may drop the bus voltage further into a third range of operation (Block 276). For example, the active rectifier may drop the bus voltage to a range between 800 and 820 VDC and the CSR may cease consumption of power (Block 277). And if the active rectifier is unable to maintain a minimum bus voltage (e.g., 800 VDC) (Block 278), the bus holdup component 220 may detect the drop in the bus voltage (Block 280) and begin to apply power to the bus to maintain the bus voltage (Block 282). In many implementations, the DC bus 118 is held up by a power source that is capable of applying a minimum voltage. For example, the minimum voltage may be 800 VDC, but this is not required in several implementations.

In various embodiments, the controller(s) performing the process of FIG. 2C may determine whether an event is detected or whether an action (e.g., applying reactive power, curtailment, shutdown, etc.) is required based on a communication received over a communication link or based on an evaluation of received sensor data and internal logic stored in a data storage medium.

An electrochemical cell-stack may spend periods of time in an “idle state” during which little or no power is being delivered to the cell-stack. An idle state may occur in response to an AC grid event, to perform system maintenance, or during other times of low-availability of power (e.g., at night when coupled with a PV array, during calm winds when coupled to wind turbines, or during a demand-response event). During such idle state times, if cells are left at in a state allowing current to flow in a reverse direction (i.e. in a direction opposite to current-flow during electrolysis), the electrodes in the cells may be susceptible to spontaneous electrochemical reactions that effectively “self-discharge” the electrodes. These self-discharge reactions may damage negative and/or positive electrodes or other cell components. Therefore, avoiding such uncontrolled idle periods may be beneficial to the long-term health of the electrochemical system, particularly for electrolyzer cell-stacks.

In order to avoid such damage during idle state periods, the cell-stack may be left at open-circuit by opening a switch, relay, or other device that creates a discontinuity in the stack's electrical circuit. In embodiments, diodes or other devices preventing reversed current flow may also be used. However, if the cell-stack is susceptible to electric currents flowing through un-controlled paths (e.g., parasitic shunt currents flowing through conductive electrolyte or make-up water channels), opening the stack's charging circuit may be inadequate to prevent self-discharge of the electrodes.

In some embodiments, it may be beneficial to apply a DC voltage to one or more of the DC-coupled resources while regulating current down to substantially zero amps during idle periods. During such periods, the cell stack regulators 108 may be configured to hold a voltage across the electrochemical cell stacks 110 while regulating current to the electrochemical cell stacks to very low levels (e.g., substantially zero amps). The voltage that is maintained may vary depending upon the particular structure and chemical composition of the electrodes of the electrochemical cells, but it is contemplated that about 0.5 to 1.5 volts per cell may be applied. As described herein, a cell-stack 110 may comprise hundreds of electrochemical cells, so hundreds of volts (e.g., 500 or more volts) may continue to be applied to the electrochemical cell stacks 110 during idle mode without applying power during an idle state period. If parasitic current paths exist in a cell-stack 110, the magnitude of such currents may be greater than zero in order to counter-act parasitic currents. The magnitude of such anti-parasitic currents may be determined empirically and/or theoretically. In such cases, the current applied by the cell-stack regulators 108 may be at least equal to the magnitude of the parasitic currents and in the same direction as current applied during electrolysis reactions under normal operation.

In some particular embodiments, a negative electrode may be susceptible to damage by oxidation. Some such electrodes may be protected during idle time periods by preventing the negative electrode half-cell voltage from becoming more positive than about −0.5 volts relative to a mercury-mercury oxide reference electrode. In specific embodiments, the negative electrode half-cell voltage may be prevented held at a voltage more negative than about −0.45 V or about −0.40 V relative to a mercury-mercury oxide reference electrode. A full-cell voltage needed to achieve such half-cell voltages may be determined empirically and/or theoretically based on the composition and/or structure of the positive electrode and/or other cell components.

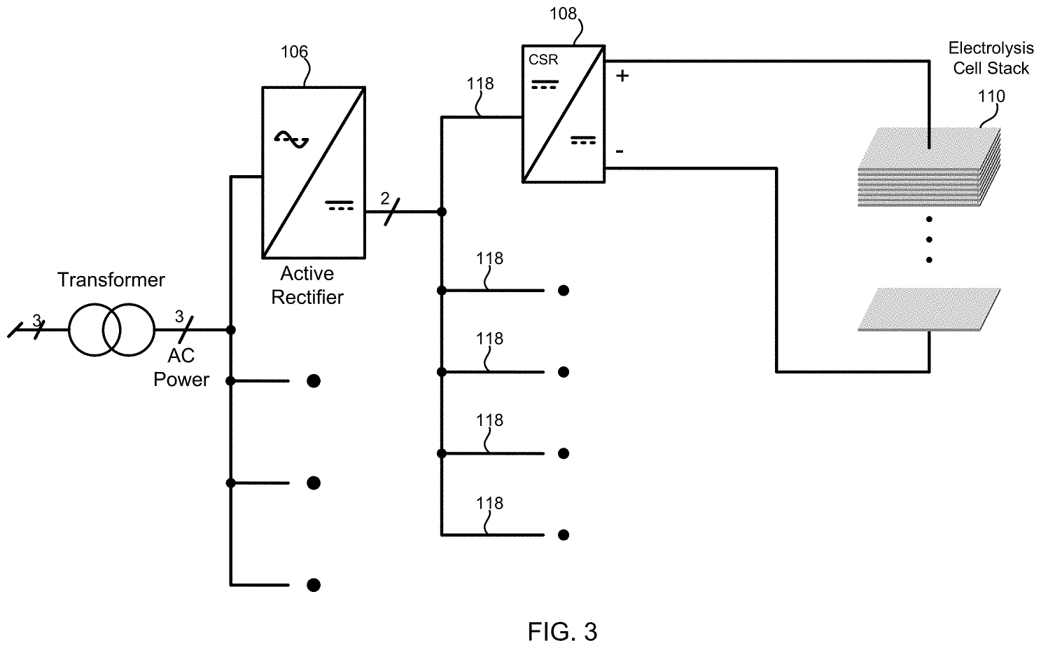

Referring next to FIG. 3, shown is a variation of the systems depicted in FIGS. 2A and 2B in which each one of multiple active rectifiers 106 is utilized to apply power to a corresponding one of multiple DC buses 118. This allows decoupling of the transformer's 104 optimum cost scaling point from the active rectifier's 106 optimum cost scaling point.

For example, the transformer's 104 optimum cost per volt-amp may be optimized at 12 MW, but the active rectifiers 106 may be cost-optimized at 3 MW, so the system may be cost-optimally realized with 4 active rectifiers 106 coupled to the transformer 104. Beneficially, the system in FIG. 3 may be implemented with the active rectifiers 106 distributed about a facility without a separate transformer 104 being required to isolate each active rectifier 106 from the other active rectifiers 106. In the implementation depicted in FIG. 3, there is a single active rectifier 106 coupled to a single DC bus 118. In other implementations, multiple active rectifiers 106 are coupled in parallel to a single DC bus 118.

Referring back to FIG. 1, for example, the depicted windfarm 114 is coupled to the DC bus 118 via a secondary active rectifier 115 that is in parallel with the active rectifier 106 (that is coupled to the AC grid 102). In these types of implementations (where more than one active rectifier is coupled to a DC bus 118), during standard conditions, the active rectifier 106 may operate in VQ-mode where the primary active rectifier regulates the voltage of the DC bus 118 while providing reactive power to the AC grid 102 (e.g., using two control loops). Additional active rectifiers, such as the secondary active rectifier 115, may operate in PQ-mode during standard conditions where power is regulated (real and reactive), but the additional active rectifiers do not attempt to regulate the voltage of the DC bus 118.

An aspect of a system implementing a primary active rectifier 106 and one or more secondary active rectifiers 115 is that the AC power on the AC grid side of the primary active rectifier 106 need not be synchronized with the AC power that is applied to the secondary active rectifier(s) 115. Thus, power from two AC grids that are not synchronized may be coupled together.

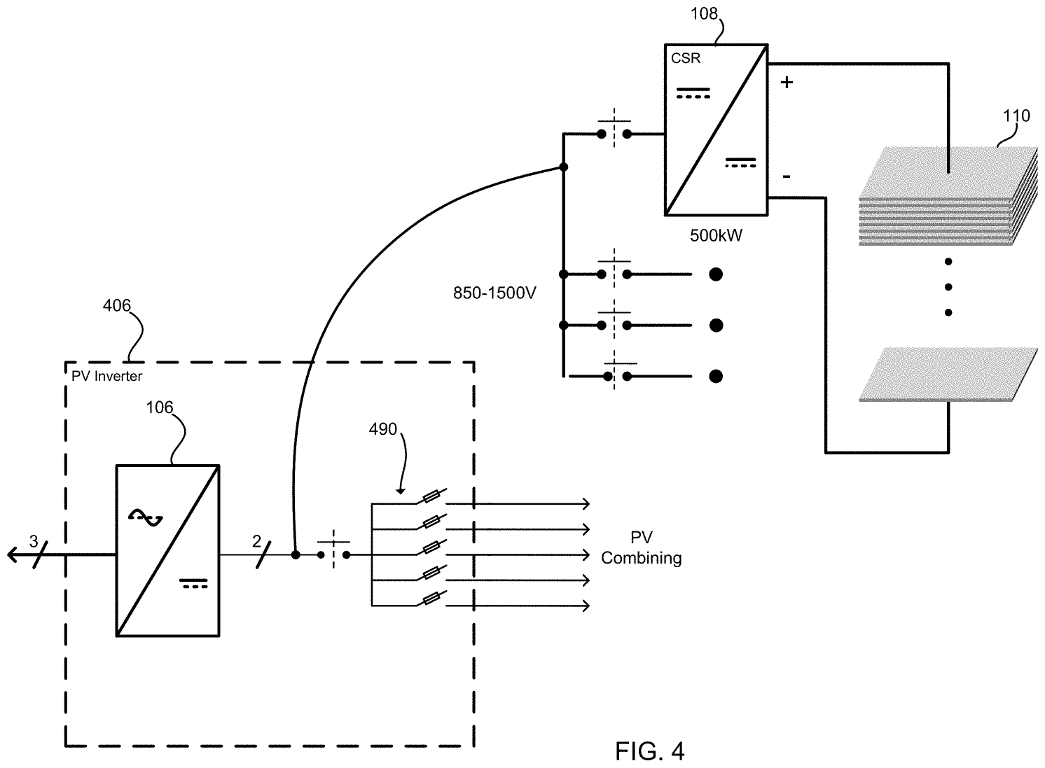

Referring next to FIG. 4, shown are aspects that may be implemented at a large photovoltaic power facility. In this implementation, the active rectifier 106 may be realized by the (inherently bi-directional) photovoltaic inverter 406 which may include the active rectifier 106 and a recombiner 490. So, instead of merely exporting power to the AC grid 102, the inverter 406 may operate as an active rectifier at night to consume power from the AC grid 102 (e.g., from nuclear, coal, wind, gas-fired, or other plant) to generate gas.

During the day, power may be provided either from the PV array 116 to the AC grid 102 and/or directly from the PV array to the electrolysis stacks. The ability to provide power from the PV array 116 to the electrolysis stacks 110 during daylight hours is especially beneficial if the power utility operating the grid 102 imposes a curtailment restriction on the PV array operator. As a specific example, if the entity owning the PV array 116 is not the power utility, and the power utility does not allow the PV array owner to dispatch power to the AC grid 102, the PV array operator may convert the electrical energy from the grid to hydrogen; thus, enabling the owner of the PV array 116 to continue to utilize (and economically benefit from) the generated electricity.

In many instances, large PV arrays are located in close proximity to major natural gas connections. So, many PV array operators are able to provide natural gas to natural gas utilities, or the hydrogen may be sold as a commodity. It is also possible the hydrogen may be utilized to generate electricity (e.g., electrochemically in a fuel cell or by combustion) that is dispatched to the AC grid after the curtailment is lifted.

Even if there is no utility-imposed curtailment, in some instances (e.g., when the temperature is low and the sun is high in the sky), the PV array 116 may generate more power than the inverter 406 is capable of handling. In these instances, excess power (beyond which the inverter 406 can deliver to the grid) may be utilized to generate hydrogen; thus, enabling the PV array operator to improve utilization of the energy generated from the array. In these situations, the inverter need not utilize maximum power point tracking at all.

Referring next to FIG. 5A, shown is an exemplary voltage-source active rectifier 506 that may be utilized to realize the active rectifiers 106 disclosed herein. As shown, the voltage-source active rectifier 506 includes a rectifier-controller 592 and six switches 503 that are controlled by the rectifier-controller 592 to actively convert AC power received at an input 505 of the voltage-source active rectifier 506 to provide boosted and voltage-regulated DC power at an output 507 of the voltage-source active rectifier 506. The voltage-source active rectifier 506 includes a voltage sensor 594 coupled to the output of the voltage-source active rectifier 506 to provide a voltage signal to the rectifier-controller 592 to enable the rectifier-controller 592 to regulate the boosted and voltage-regulated DC power, which is provided to the DC bus 118, and the DC bus 118 is coupled to the cell-stack regulators 108. In addition, the voltage-source active rectifier 506 includes a capacitor (e.g., 1 to 10 millifarads or more) disposed across the DC output that is coupled to the DC bus 118.

It is certainly contemplated that alternative designs may be utilized to realize the active rectifier 106. For example, FIG. 5B depicts a single phase one-line diagram of various potential designs (including the design depicted in FIG. 5A). As shown, the active rectifier 506B is represented by a resistive component 595 (coupled to the AC grid 102 of the utility) and an inductor 596 that is coupled to a voltage source. In general, the voltage-source active rectifier 506B operates on a principle of synthesizing a voltage on the device's side of the inductor 596.

In operation, a utility provider provides a sinusoidal voltage, and the active voltage source rectifier 506B can synthesize in any wave shape desired, using pulse modulation in a switch mode design (e.g., as shown in FIG. 5A), a pulse width modulated representation of the same frequency sine wave as the utility. The sine wave may vary in amplitude and phase, but the synthesized wave approaches a sine wave in form. The depicted inductor 596 acts as a filter for the higher frequency pulse with modulated components, which are essentially rendered irrelevant, and it also separates the utility voltage source from the voltage source of the active rectifier 506B.

If the synthesized voltage is the same as the utility voltage, there is no power flow because the resultant voltage difference across the resistor-inductor combination is zero. But the reactance of the inductor 596 far surpasses the relevance of the resistor 595 in this model, so if current lags the phase of the synthesized voltage, then power is drawn. And reactive power can also be achieved at the input to the active rectifier 506B. So, when the resistance 595 is low, there is a near perfect coupling in the sense that a phase angle of the synthesized sine wave dictates real power flow and the magnitude controls reactive power flow. So, the combination of creating a sine wave of a particular magnitude and phase dictates power flow direction; thus, the active rectifier 506B can operate as an inverter, and also provides grid support services to utilities. Thus, as used herein, the term active rectifier means a device that is capable of converting AC power to DC power, but in many implementations, it is a device also capable of converting DC power to AC power.

Although inefficiencies may lead one away from utilizing an active rectifier, the multi-stage approach that Applicant discloses herein enables the benefits of the voltage source active rectifier 506B. For example, harmonic current injected into the grid 102 from the standard silicon-controlled rectifiers are substantially removed in many implementations, and power factor (in terms of both positive and negative reactive power) is something that is completely dispatchable. Moreover, the voltage source active rectifier 506B is not prone to exciting pre-existing resonances. But as discussed further herein (a filter capacitor of the voltage source active rectifier) may create resonances (but it does not actually excite them).

The active rectifier 506B may be relatively large. Although cost optimization points are changing all the time, 3 MW active rectifiers are currently very viable devices.

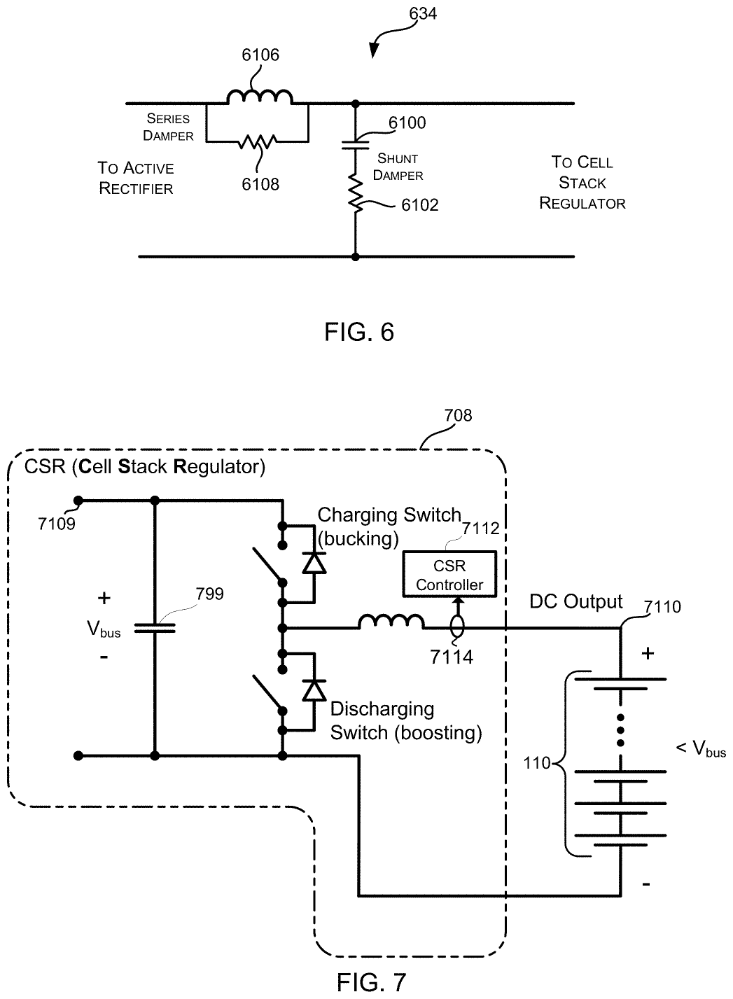

Referring next to FIG. 6 shown is an exemplary damper 634 that may be disposed between a voltage-source active rectifier (e.g., the active rectifier 106) and a corresponding one of the cell-stack-regulators 108 in order to damp ringing related to large distances between the components. As described further herein, each of the plurality of dampers 634 includes inductive, capacitive, and resistive elements to damp oscillations between the at least one voltage-source active rectifier and the corresponding one of the bucking cell-stack-regulators.

As discussed above, a distance between the active rectifier 106 and the cell-stack regulator 108 may be 30 meters or more, and the inductance of the transmission line (of the DC bus 118) may be 500 nanohenrys (nH) per meter or more. For example, the transmission line may be 30 meters and the inductance of the transmission line may be 750 nH. So, the inductance of the transmission line between the active rectifier 106 and the cell stack regulator 108 may be about 25 microhenrys (μH). Assuming that the output capacitor 591 of the active rectifier 106 and the input capacitor 799 of the cell stack regulator 108 are each 4 millifarads, there will be substantial ringing at about 700 Hertz.

In general, to critically damp the system, 0.1 Ohms are needed, and the cable will be a very low resistance (e.g., 700 micro-ohms). To critically damp the system over a range of frequencies both the series and shunt elements are needed. A “critically damped” system is neither under-damped (causing decaying oscillations) nor over-damped (causing excessive losses).

In other embodiments, active damping may also be utilized instead of, or in addition to, the passive damping approach of FIG. 6. As used herein, “active damping” may refer to an electronic controller actively varying an applied electronic damping effect based on signals received from one or more sensors in a closed feedback loop.

To understand functional aspects of the damper 634 it is helpful to understand the electrical interaction between the active rectifier 106 and the cell stack regulators 108. As shown in FIG. 5A the exemplary active rectifier 506 includes the output capacitor 591 across its output 507, and as discussed further herein with reference to FIG. 7, an input of each of the cell stack regulators 108 includes an input capacitor 799 across the positive and negative conductors at the input side of the CSR 108. If the active rectifier 106 and the cell stack regulator 108 are positioned closely together (e.g., integrated within a common housing and/or separated by conductors of sufficiently low resistance and inductance), impedance and inductance will be low enough to minimize ringing, obviating any need for a damper. But in the context of the utility scale DC distribution system (e.g., described with reference to FIG. 1) where a sufficiently large physical and electrical distance exists between the active rectifier 106 and the cell stack regulators 108, there will likely be substantial ringing between the active rectifier 106 and one or more of the cell stack regulators 108.

As shown in FIG. 6, the exemplary damper 634 (configured to mitigate the ringing) may include a capacitor 6100 (e.g., an electrolytic capacitor, ceramic capacitor, or film capacitor) in connection with a resistor 6102 across the DC lines 6104 that feeds the cell stack regulator 634. The capacitor 6100 of the damper 634 operates as a shunt damper and it may be substantially larger (e.g., an order of magnitude or more) than the capacitor (e.g., 799) at the input of each of the cell stack regulators 108. The exemplary damper 634 also includes an inductor 6106. In operation, the capacitive filter functions to dampen low frequencies while the inductive filter functions to dampen high frequencies. In some embodiments, the inductor 6106 may be in the range of 10 to 50 microhenrys (in parallel with a resistor 6108) in series with an input of the cell stack regulators. Those of ordinary skill in the art will appreciate, in view of the present disclosure, that the size of the capacitor 6100, inductor 6106 and resistors 6102, 6108 may be selected based upon the DC bus 118 inductance and number of CSRs 108.

Referring to FIG. 7, depicted is an exemplary cell stack regulator (CSR) 708 that is configured to operate as a bucking DC-to-DC converter to charge a cell stack 110. But in addition, the depicted cell stack regulator 708 is also configured to operate as a boosting DC-to-DC converter to discharge an energy storage device. So, the cell stack regulator 708 depicted in FIG. 7 is certainly not limited to regulating power to electrolysis cell stacks 110. It may, for example, provide DC power to a variety of DC resources, and in addition, it may also draw power from a variety of DC storage devices (such as batteries) to provide power to the DC bus 118 (which in turn may be provided to the AC grid 102 if the AC grid 102 needs support). For example, the cell stack regulator may deliver DC power to other energy storage devices or other DC loads such as batteries, flow batteries, flywheels, gas compressors, hydraulic pumps, etc.

As shown, the cell stack regulator 708 includes a DC input 7109 and a DC output 7110, and an input-capacitor 799 is disposed across the DC input 7109 of the cell stack regulator 708. When operating as a bucking DC-to-DC converter, the cell stack regulator 708 provides regulated current to the DC output 7110. In addition, the cell stack regulator 708 includes a CSR controller 711 that is coupled to a current transducer 7114 that is disposed to sense current at the output of the cell-stack-regulator 708 to provide a signal indicative of the current at the DC output 7110.

An output voltage of the CSR 708 that is close to the input voltage of the CSR 708 enables a simple DC-to-DC converter to be implemented. For example, the cell stack 110 may operate at 850 Volts while the DC input 7109 to the CSR is 900 Volts. The relatively high voltage of the cell stack 110 means that the current through the cell stack 110 is relatively low; thus, conductors may be sized smaller at a lower cost than prior art systems that utilize lower voltage cell stacks. As another example, at the DC input, the voltage may be 1000 volts, and at the DC output the DC voltage may be 950 volts. But other voltage levels are certainly contemplated. In various embodiments, a CSR may be sized and configured to deliver a voltage suitable for a cell stack with which the CSR is designed to operate. Such cell stacks may be configured to operate at a range of DC voltage and current as further described herein.

As discussed above, the active rectifier 106 may operate as an inverter that has two control loops that are orthogonal to each other. One controlling reactive power and the other controlling DC bus voltage regulation to source or sink whatever amount of power to maintain a constant bus voltage. To operate in a reactive power/real power flow mode, a power source may be utilized.

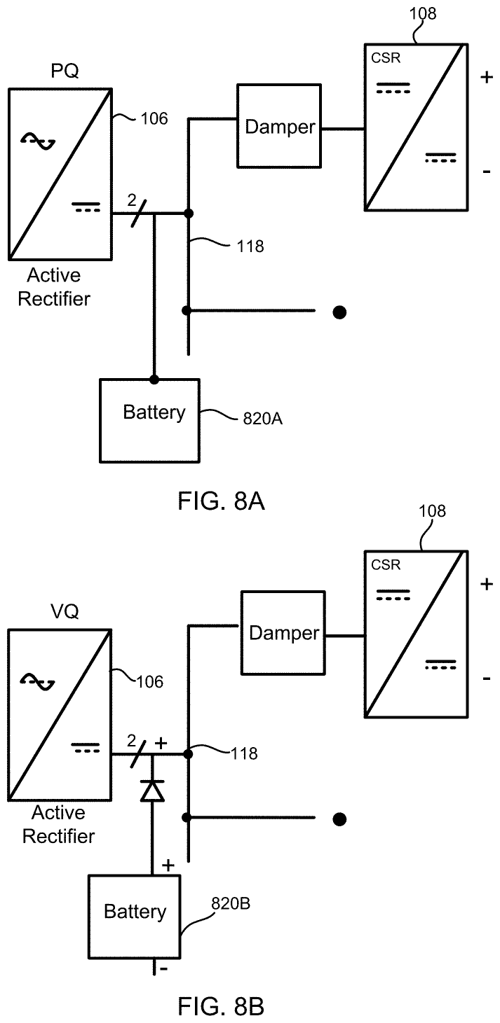

Referring next to FIG. 8A shown is an exemplary implementation of a DC holdup component. Shown is an active rectifier 106 coupled and a cell stack regulator 108 via the DC bus 118. As shown, a relatively large battery may be coupled to the DC bus while the active rectifier 106 operates in P/Q mode.

Alternatively, as shown in FIG. 8B, the active rectifier 106 operates in VQ mode to regulate bus voltage and provide reactive power to the grid 102. When there is an event (e.g., short, fault, islanding), the voltage of the grid goes away or drops. The utility may direct the system (e.g., via DNP3 SCADA connection) to support the grid. In the case of a sag, the active rectifier can draw power from the DC bus 118.

But if most or all power on the grid goes away, the utility may want the active rectifier 106 to provide maximum current back to the grid to assist the grid to forestall a massive regional voltage collapse until a fault is cleared. If there is no voltage on the grid 102, then there is no voltage to prop up the DC bus 118 using the active rectifier 106, so the DC bus 118 should be kept up. In the implementation depicted in FIG. 8B, a battery 820B is coupled to the DC bus 118 via a diode, (e.g., a high voltage power diode). The battery sits at a voltage that is just below the voltage of the active rectifier. For example, if the DC bus 118 normally sits at 1000 volts, the battery may be at 900 Volts.

In yet another alternative, an energy storage device (e.g., battery) may be coupled to the DC bus 118 via a cell stack regulator (operating in boost mode) to maintain the DC voltage. In this type of implementation, an active control mode switch may be implemented to control the operation of the CSR and the active rectifier 106.

### Electrolyzer System Grounding

In a high-voltage power distribution system such as those described above, an electrical ground may he required in order to mitigate ground faults and/or to provide a reference point against which analog and/or digital circuits may measure voltage. Many existing ground-reference configurations may create challenges when managing power distribution to cell stacks from individual cell-stack regulators.

For example, in most flowing electrolyte systems (e.g., flow batteries, some electrolyzers), electric currents may flow through continuous steams of electrolyte in conduits, thereby causing the electrolyte itself to become an electric conductor. Such flowing electrolyte systems typically involve electrolyte reservoirs, piping, and other components which may be electrically grounded via mechanical connections to a ground-based structure. However, the actual electrical ground state of such a “grounded” electrolyte-containing structure may be unknown or variable because the mechanical connections may not be adequate to establish a true earth ground. As a result, such grounds may be inadequate to fully guard against destructive ground faults or may be difficult to control against.

In flowing electrolyte systems as well as systems with non-flowing electrolytes (e.g., sealed battery systems, solid-electrolyte systems, PEM systems, etc.), accidental ground faults may cause major disruptions to the system's operation. The ability to electrically isolate or shut down an individual cell stack without requiring that other cell stacks be taken offline may offer substantial benefits in improved up-time.

To achieve such individual cell stack isolation, it may be beneficial to provide a ground reference common to all points within the power distribution system that may be used to monitor for ground faults and to selectively disconnect as few system components as possible while a ground fault or other failure is identified and repaired. In various embodiments, earth ground connections may be configured to minimize resistance, or to establish at least a minimum threshold resistance such as by one or more resistors, diodes, or other resistive components.

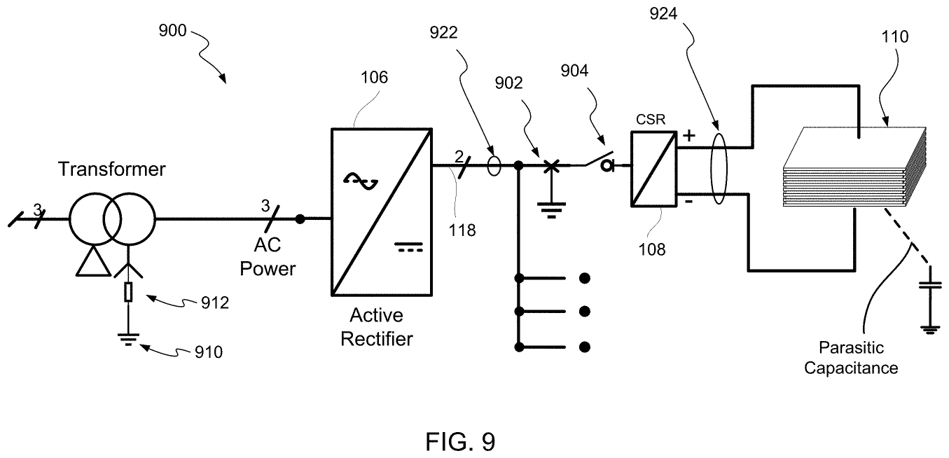

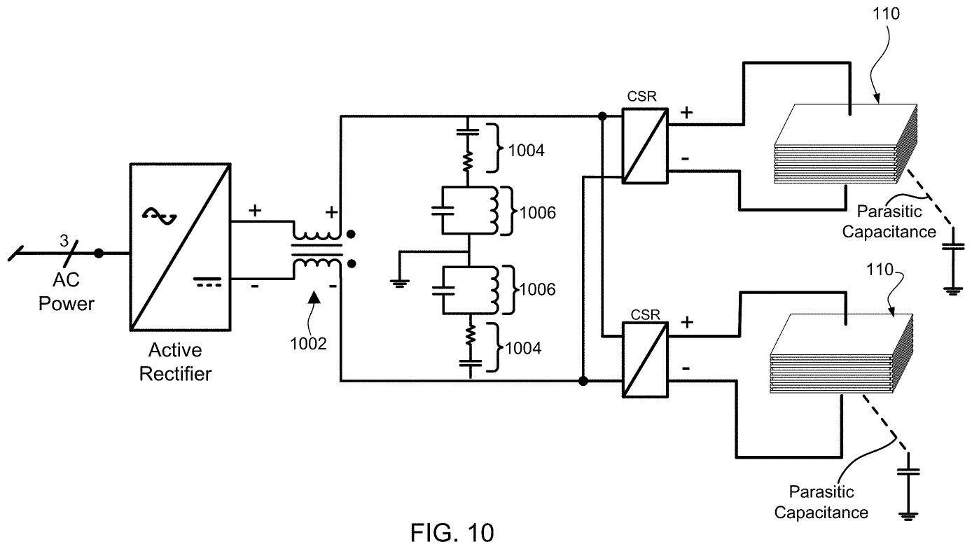

FIG. 9 schematically illustrates a cell stack power distribution system 900 showing some example grounding locations relative to other system components. As shown, the system 900 may receive 3-phase power from a grid or other AC source. The three-phase power may be received by a transformer 904, which may include one or more of a “delta” configuration, a “Y” (or “star”) configuration, and an “interconnected-star” (or “zig-zag”) configuration. In some embodiments, the transformer 904 may include at least one set of windings connected in a star or interconnected-star configuration, which may be positioned as primary windings or as secondary windings,

The location of the ground connection within the system 900 may have significant implications for the safety and reliability of operating the cell stacks and power distribution systems. For example, in some embodiments, a ground connection may be made at one pole of the DC bus 118 (e.g., on a negative rail of the DC bus as shown by the “X” at 902). Such a grounding location effectuates a DC-side ground referencing and would allow for detection of a ground fault in a cell stack 110 or in a cell-stack regulator 108. A switch or circuit breaker 904 may be provided between the ground 902 and the CSR 108 in order to selectively shut off only the CSR and cell stack associated with the fault.

One disadvantage of such a DC-side ground referencing configuration would be that a ground fault in the cell stack 110 would pass current through the negative DC conductor of the CSR 108 to the ground 902, which may damage the CSR 108 if large currents are involved, Another disadvantage of DC-side ground referencing is that an isolation transformer may be required to galvanically isolate the active rectifier 106 from the AC power and to provide a voltage ratio change. Isolation transformers, however, add additional inefficiencies, complexity, weight and substantial cost to the system.

Another possible ground location is shown at 910, in which the common conductor of the Y-configured (or zig-zag configured) transformer windings is shown connected to earth ground via a resistive connection 912. In this approach, the ground-connected common conductor achieves an AC-side around reference, which may become the singular electrical system ground reference for the active rectifier 106 and one or more CRSs 108 and cell stacks 110 coupled to the active rectifier 106. Although not shown in FIG. 9, there may be multiple active rectifiers 106 coupled to the transformer 904 and multiple CSRs 108 coupled to each active rectifier 106. In various embodiments, the resistive connection 912 may take the form of one or more resistors, diodes (e.g., Schottky diodes), or other electrical or electronic components with a substantial electrical resistance that will significantly limit any current flowing to ground. In various embodiments, the resistance of the resistive connection 912 may be up to about 10 ohms operating via a fast-acting ground fault circuit interrupt device (GFCI).

In the case of a Y or interconnected-Y with a grounded common point, a “common ground” electrical conductor (also referred to as a star point) may be connected to the grounded common point, and the common ground conductor may be provided throughout the system 900, providing all system components with the same common ground reference point. With a common ground reference, any subsequent ground fault within any DC-bus-connected accessory will result in fault current that may be localized to the offending accessory,

When an AC-side ground reference is implemented (e.g., at 910) instead of a DC-side reference (e.g., at 902), a ground-path connection, which includes the cell stack regulator 108 and the cell stack 110, is created between the active rectifier 106 and ground, The connection between the cell stack 110 and ground is created by inherent parasitic capacitive coupling that may exist between the cell stack and ground. When an isolation transformer is not utilized between the active rectifier 106 and the distribution system, high frequency voltages due to the switching of the active rectifier 106 may cause problematic currents to occur in the ground-path connection. And once coupled to ground, these currents would form a current path, via ground, that travels through the AC-side-ground-referenced-transformer back to the active rectifier 106.

Referring next to shown is a schematic representation of a ground-path filter system to enable the problematic currents discussed above to be abated without the use of an isolation transformer while also solving additional problems that occur when an isolation transformer is removed. As shown, the filter system includes a common-mode choke 1002 used in connection with damper networks 1004 and a parallel resonant tank circuits 1006 that operate as traps for a third harmonic of the AC power frequency voltages that may be present in connection with the embodiments described with reference to FIGS. 9. The third harmonic may be, for example, 180 Hz or 150 Hz depending upon whether a fundamental frequency of the AC power is 60 Hz or 50 Hz, respectively. In operation, the damper networks 1004 filter the high frequency voltages (e.g., voltages at frequencies greater than 1000 Hz) and the parallel resonance tank circuits 1006 operate to create a high impedance for the third harmonic frequencies. As a consequence, the damper circuits 1004 remove potentially harmful high frequency currents and the parallel resonance tank circuits 1006 prevent the third harmonic voltages from creating substantial energy losses by preventing current at the third harmonic from flowing through the damper networks 1004.

Although not required, the capacitor in each of the damper networks 1004 may be realized by a 60 microfarad capacitor and the resistor in each of the networks 1004 may be implemented with a 50 ohm resistor. In addition, the capacitor in the parallel resonance tank circuits 1006 may be implemented with a 40 microfarad capacitor and the inductor may be realized by a 19.5 millihenry inductor. The combination of the parallel inductor and capacitor act as an open circuit at frequencies of the third harmonic allowing high frequencies to be attenuated but not dissipating excessive power at the third harmonic.

The common-mode choke 1002 (also referred to as an attenuating component) functions to prevent high frequency currents from occurring by attenuating high frequency voltages. Specifically, the common mode choke 1002 is a high impedance element (in a portion of a potential ground path) that prevents high frequency currents from occurring. Without the attenuating components, the high frequency voltages that may be generated by the active rectifier 106 would induce high frequency currents at the cell stacks 110 that would be capacitively coupled to ground via a parasitic capacitance between the panels of the cell stacks and ground. And once coupled to ground, these currents would form a current path via ground that travels through the ground-referenced transformer (shown in FIG. 9), back to the active rectifier 106. Those of ordinary skill in the art refer to these high frequency currents that flow via ground as “common-mode” currents. And without the common-mode choke 1002 disposed to operate as an attenuating component, the common-mode currents may adversely affect electrical components that are a part of the cell stack power distribution system 900.

When an attenuating component (such as the common-mode choke 1002) is utilized, the common-mode choke 1002 in connection with the parasitic capacitance-to-ground created by the panels of the cell stacks may create a potential harmful instability. In such cases damping networks 1004 may be used to damp the potentially harmful resonance that creates this potential instability.

As discussed further herein, it has also been found that eliminating the isolation transformer that is normally interposed between an active rectifier and the transformer depicted in FIG. 9 may lead to high frequency (e.g., >1 kHz) common mode voltages propagating to the cell stacks 110. These high frequency voltages may vary in frequency depending upon the switching frequency of the active rectifier 106, but they may create adverse consequences relative to other active rectifiers 106 that may be coupled to the distribution system or other loads in the cell stack power distribution system 900.

In addition, it has been found that when the high frequency voltages are filtered, the third harmonic voltages that originate from pulse width modulation saturation may also propagate through the damper networks 1004, which may create substantial energy losses and heat generation. Moreover, 60 Hz voltage fluctuations due, for example, to asymmetrical loading, may propagate through the distribution system 900.

As a consequence, the common mode choke 1002 in the exemplary embodiment is implemented in connection with the damping networks 1004 to remove the high frequency voltages (e.g., >1 kHz) in connection with parallel resonant tank circuits 1006 that function as low frequency (e.g., 180 Hz or 150 Hz) traps to prevent the flow of the currents at the third harmonic through the damping networks 1004.

In various embodiments, the system may be configured to monitor for ground faults at one or more locations within the system. For example, current passing through a positive conductor and a negative conductor at a single point within the system may be monitored. If an unexpectedly large difference in currents flowing in the positive and negative conductors (or a difference exceeding a threshold value) occurs, then a ground fault may be indicated. In some embodiments, currents may be monitored at output lines leaving the active rectifier 106 at 922 and/or at output lines leaving one or more (or each) of the cell-stack regulators 108 at 924.

### Electrolyzer Cell Stacks

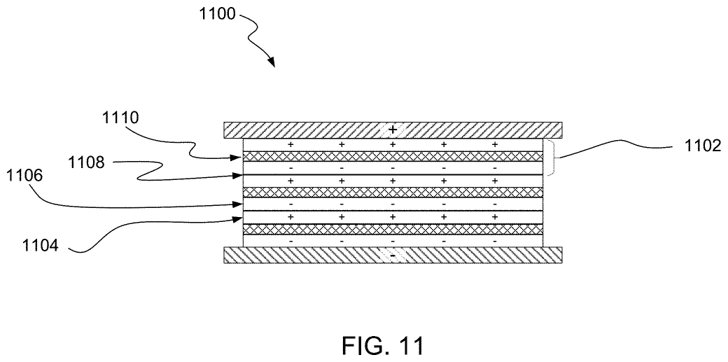

FIG. 11 shows an example cell stack 1100 in the form of a single bipolar stack of electrochemical cells 1102. The cell stack 1100 may generally include a plurality of individual cells 1102 arranged in a bipolar configuration in which a positive electrode 1104 of one cell is in conductive contact with a negative electrode 1106 of an adjacent cell, typically (though not necessarily) via a bipolar plate 1108. Positive 1104 and negative 1106 electrodes of a single cell 1102 may be separated by an electrically insulating, but ionically conductive separator 1110. Bipolar cell stacks may be configured and used for various purposes such as a chemical production stack, flow battery, electrolyzer, etc.

In such a bipolar stack, an electric current passes through the stack of cells from one end to the other. The total voltage of a stack is generally a function of the electrochemistry of the cells and the number of cells. Assuming all cells utilize the same chemistry, the voltage of the stack is the voltage of one cell multiplied by the number of cells.

Electric currents in a bipolar stack are commonly reported in terms of “current density,” an area-normalized metric with common units of amps per square centimetre of planar electrode area. In electrolyzer systems, current density is generally a controlled applied operating parameter while voltage is a response dependent on the chemistry and construction of the cells affecting the cell's electrical resistance.

When configured as an electrolyzer, the cell stack 1100 may be configured to consume electric power by directing current to the cells 1102 in which electrochemical reactions occur to produce a product, such as hydrogen and/or oxygen gas. The stack 1100 may be further configured with gas collection conduits, manifolds, or other structures to collect produced gaseous or liquid products. In various embodiments, each cell may contain an electrolyte in liquid, gel, or solid form. For example, an electrolyte may be an aqueous liquid such as an acidic or alkaline solution. In other embodiments, a separator may be configured to be or to include a solid or a gel material that conducts ions between the electrodes while preventing electrical contact between the electrodes of a cell.

In some embodiments, cell stacks configured for water electrolysis may be configured to produce stack voltages of 500V to 3000V or more. Therefore, a cell stack regulator may be configured to deliver power at a voltage of 500V or more, 900V or more, 1200V or more, 1500V or more, 2000V or more, or 3000V or more. In some particular embodiments, a cell stack may be operated in a range of about 850 to 900 V.

In some embodiments, cell stacks configured for water electrolysis may be configured to operate at current densities of between 500 mA/cm² and 3,000 mA/cm² or more. In some particular examples, a cell stack may be operated at a current density of 500 mA/cm², 600 mA/cm², 700 mA/cm², 800 mA/cm², 900 mA/cm², 1000 mA/cm², 1100 mA/cm², 1200 mA/cm², 1300 mA/cm², 1400 mA/cm², 1500 mA/cm², 1600 mA/cm², 1700 mA/cm², 1800 mA/cm², 1900 mA/cm², 2000 mA/cm², 2100 mA/cm², 2200 mA/cm², 2300 mA/cm², 2400 mA/cm², 2500 mA/cm², or more.

In some embodiments, cell stacks configured for water electrolysis may be sized to have electrodes with a planar area of 500 cm² to 1,000 cm² or more. In some particular examples, cell stacks may have electrodes with a planar area of 500 cm², 600 cm², 700 cm², 800 cm², 900 cm², 1000 cm², or more.

In some embodiments, cell stacks configured for water electrolysis may be configured to operate with a combination of cross-sectional area and current density to produce total currents of about 500 amps to about 3000 amps. Therefore, a cell stack regulator may be configured to deliver power at a desired DC voltage at current of less than or equal to 3000 A, less than or equal to 2000 A, less than or equal to 1500 A, less than or equal to 1200 A, less than or equal to 1000 A, less than or equal to 800 A, or less than or equal to 500 A.

Combining a smaller-than-typical electrode area with a larger-than-typical stack length (i.e., more cells and higher voltage), produces a stack with much higher characteristic impedance, which allows for the use of active rectifiers and switch-mode DC/DC regulators (i.e., CSRs). Thus, for example, cell stacks used in combination with the systems and methods described herein may have a characteristic impedance of between 1 ohm and 10 ohms.

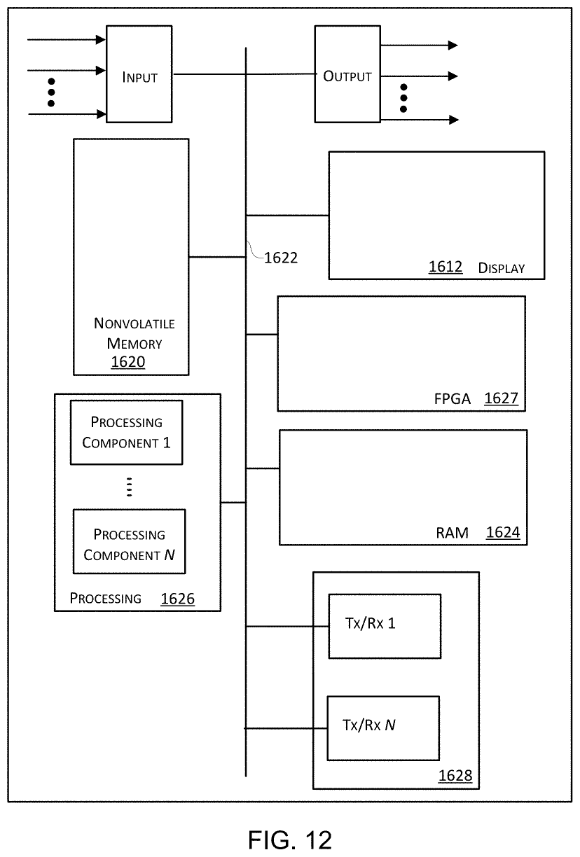

Referring next to FIG. 12, shown is a block diagram depicting physical components that may be utilized to realize the one or more aspects of the embodiments disclosed herein. For example, aspects of the controllers (e.g., the coordinated controller 238, rectifier controller 592, and CSR controller 7112) may be realized by the components of FIG. 12. As shown, in this embodiment a display portion 1612 and nonvolatile memory 1620 are coupled to a bus 1622 that is also coupled to random access memory (“RAM”) 1624, a processing portion (which includes N processing components) 1626, a field programmable gate array (FPGA) 1627, and a transceiver component 1628 that includes N transceivers.

Although the components depicted in FIG. 12 represent physical components, FIG. 12 is not intended to be a detailed hardware diagram; thus, many of the components depicted in FIG, 12 may be realized by common constructs or distributed among additional physical components. Some components of FIG. 12 may be omitted in some implementations. Moreover, it is contemplated that other existing and yet-to-be developed physical components and architectures may be utilized to implement the functional components described with reference to FIG. 12.

This display portion 1612 generally operates to provide a user interface for an operator of the power supply systems described herein. The display may be realized, for example, by a liquid crystal display or AMOLED display, and in several implementations, the display is realized by a touchscreen display to enable an operator of the power supply systems to modify control aspects and to view operating parameter-values (e.g., current, voltage, reactive power, operating trends, etc.) of the disclosed power supply systems. In general, the nonvolatile memory 1620 is non-transitory memory that functions to store (e.g., persistently store) data and processor executable code (including executable code that is associated with effectuating the methods described herein). In some embodiments for example, the nonvolatile memory 1620 includes bootloader code, operating system code, file system code, and non-transitory processor-executable code to facilitate the execution of the functionality of the logic and control components described herein.

In many implementations, the nonvolatile memory 1620 is realized by flash memory (e.g., NAND or ONENAND memory), but it is contemplated that other memory types may also be utilized. Although it may be possible to execute the code from the nonvolatile memory 1620, the executable code in the nonvolatile memory is typically loaded into RAM 1624 and executed by one or more of the N processing components in the processing portion 1626.

The N processing components in connection with RAM 1624 generally operate to execute the instructions stored in nonvolatile memory 1620 to facilitate execution of the methods disclosed herein. For example, non-transitory processor-executable instructions to effectuate aspects of the methods described herein may be persistently stored in nonvolatile memory 1620 and executed by the N processing components in connection with RAM 1624. As one of ordinarily skill in the art will appreciate, the processing portion 1626 may include a video processor, digital signal processor (DSP), graphics processing unit (GPU), and other processing components.

In addition, or in the alternative, the FPGA 1627 may be configured to effectuate one or more aspects of the methodologies described herein. For example, non-transitory FPGA-configuration-instructions may be persistently stored in nonvolatile memory 1620 and accessed by the FPGA 1627 (e.g., during boot up) to configure the FPGA 1627 to effectuate one or more functions of the control and logic components described herein.

As one of ordinary skill in the art in view of this disclosure will appreciate, the depicted input and output modules may be used for several different purposes. Sensors, for example, may be coupled to the input module, and the output module may generate control signals.

The depicted transceiver component 1628 includes N transceiver chains, which may be used for communicating with external devices via wireless or wireline networks. Each of the N transceiver chains may represent a transceiver associated with a particular communication scheme (e.g., SCADA, DNP3, WiFi, Ethernet, Modbus, CDMA, Bluetooth, NFC, etc.).

It should be recognized that various aspects of particular implementations described with reference to separate drawing figures may be combined.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, or C should be construed to mean a logical (A OR B OR C), using a non-exclusive logical OR, and should not be construed to mean “at least one of A, at least one of B, and at least one of C.”

“Adapted,” “operative,” “capable,” or “configured” as used herein means that the indicated elements or components are implemented using one or more of mechanical, material, and electrical constructs. These constructs include hardware (which may or may not be programmed with software and/or firmware as the means for the indicated components to implement their functionality. The word “exemplary” is used herein to mean “serving as an example, instance, or illustration.” Any embodiment described herein as “exemplary” is not necessarily to be construed as preferred or advantageous over other embodiments.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although specific embodiments have been described in detail, it should be understood that many modifications, changes, substitutions or alterations will be apparent to those skilled in the art without departing from the scope of the present invention.

What is claimed is:

1-36. (canceled)

37. A water electrolysis power supply system comprising:
at least one voltage-source active rectifier configured to provide power-quality services to an AC power grid that provides AC power at an input of the voltage-source active rectifier, and the voltage-source active rectifier is configured to provide voltage-regulated DC power at an output of the at least one voltage-source active rectifier;
a plurality of bucking cell-stack-regulators (CSRs), wherein each of the bucking cell-stack-regulators includes a DC input and a DC output, wherein the DC input to each of the bucking cell stack regulators is coupled to the voltage-regulated output of the voltage-source active rectifier, and wherein each of the bucking cell-stack-regulators is configured to regulate output current down to zero volts; and
a plurality of electrolysis cell stacks, wherein each of the electrolysis cell stacks is coupled to a corresponding one of the plurality of cell-stack regulators, and wherein each of the electrolysis cell stacks includes a plurality of electrolysis cells arranged in series.

38. The water electrolysis power supply system of claim 37 further comprising:
an output-capacitor disposed across the output of the at least one voltage-source active rectifier;
an input-capacitor disposed across the DC input of each of the bucking CSRs, and;
a plurality of dampers, wherein each of the dampers is disposed between the at least one voltage-source active rectifier and a corresponding one of the bucking cell-stack-regulators, each of the dampers is configured to damp ringing between the output capacitor of the voltage-source active rectifier and the input capacitor of the CSR.

39. The water electrolysis power supply system of claim 37, wherein the output of the voltage-source active rectifier applies the voltage-regulated DC power at a DC bus;
wherein at least one of the CSRs is configured to consume power from the DC bus to provide current to an electrolysis cell stack, and wherein at least another one of the CSRs is configured to draw power from a DC source and provide power to the DC bus; and further comprising:
a coordinated controller that is coupled to the at least one voltage-source active rectifier and the plurality of CSRs, wherein the coordinated controller is configured to, in response to an event signal that indicates an event has affected the AC power, prompt the at least one voltage-source active rectifier to apply volt-ampere reactive (VAR) power to the input of the voltage-source active rectifier and trigger the plurality of CSRs to cease operating.

40. The water electrolysis power supply system of claim 37, further comprising:
an output-capacitor disposed across the output of the at least one voltage-source active rectifier;
an input-capacitor disposed across the DC input of at least one of the cell-stack-regulators;
a damping system disposed between the at least one voltage-source active rectifier and the at least one cell-stack-regulator, wherein the damping system includes:
a series combination of a damping capacitor and damping resistor, wherein the series combination is disposed in parallel to the output-capacitor and the input capacitor; and
a parallel combination of a damping inductor and another damping resistor, wherein the parallel combination is disposed along a positive voltage line of the DC input to the at least one cell-stack-regulator.

41. The water electrolysis power supply system of claim 39, further comprising at least one Y-configured transformer with a common conductor connected to earth ground by an impedance, and a common ground conductor extending from the transformer, through the voltage-source active rectifier, and through at least one cell-stack regulator, wherein the common ground conductor is separate from positive and negative DC conductors and from live and neutral AC conductors.

42. The water electrolysis power supply system of claim 41, further comprising a current sensor arranged to monitor current in positive and negative conductors connecting the at least one cell-stack regulator to an electrolysis cell stack.

43. The water electrolysis power supply system of claim 42, further comprising a current sensor arranged to monitor current in positive and negative conductors connecting the active rectifier to the DC bus.

44. The water electrolysis power supply system of claim 39, wherein the voltage-regulated DC power applied to the DC bus is greater than or equal to 500V.

45. The water electrolysis power supply system of claim 43, wherein the impedance includes at least one of a resistor or a diode.

46. The water electrolysis power supply system of claim 45 wherein the impedance is less than 10 ohms.

47. The water electrolysis power supply system of claim 43 including:
a ground-path filter system disposed and configured to reduce currents in a ground-path that includes at least one bucking cell-stack-regulator; at least one cell stack; a parasitic capacitance between the at least one cell stack and ground; the common ground conductor extending from the transformer; and the voltage-source active rectifier.

48. The water electrolysis power supply system of claim 47 including: a common-mode choke configured to attenuate high frequency voltages in the ground path;
a damper network to mitigate against a resonance condition; and
a low frequency trap configured to prevent a flow of current through the damper network at a third harmonic of a fundamental frequency of the AC power.

49. A method of powering a plurality of electrosynthetic cell stacks, comprising:
performing a first voltage conversion using an active rectifier to convert a first input AC voltage to a first output DC voltage;
supplying the first output DC voltage from the active rectifier to a DC bus; supplying the first output DC voltage from the DC bus to a second input at a bucking cell-stack regulator;
performing a second voltage conversion using the bucking cell-stack regulator, from the second input DC voltage to a second output DC voltage; supplying the second output DC voltage to a first electrosynthetic cell stack.

50. The method of claim 49, wherein the second output voltage supplied to the DC bus is greater than or equal to 500V.

51. The method of claim 49, further comprising monitoring electric current in a positive conductor, a negative conductor, and a common ground conductor separate from the positive conductor and the negative conductor at a point between the active rectifier and the DC bus, determining that a difference between a first current in the positive conductor and a second current in the negative conductor exceeds a threshold, and transmitting a control signal to stop delivery of the second output DC voltage to the DC bus.

52. The method of claim 49, further comprising monitoring electric current in a positive conductor, a negative conductor, and a common ground conductor separate from the positive conductor and the negative conductor at a point between the cell stack regulator and the electrosynthetic cell stack, determining that a difference between a first current in the positive conductor and a second current in the negative conductor exceeds a threshold, and transmitting a control signal to stop delivery of DC voltage from the cell-stack regulator to the electrosynthetic cell stack.

53. The method of claim 52 including: holding up a voltage of the DC bus with a component other than the active rectifier when the active rectifier is unable to maintain the DC bus at a minimum voltage.

54. The method of claim 53 wherein the holding up the voltage includes holding up the voltage with a diode-connected energy storage device.

55. The method of claim 54 wherein the energy storage device is a backup battery.

56. A water electrolysis power supply system comprising:
at least one voltage-source active rectifier including a rectifier-controller and switches, wherein the switches are controlled by the rectifier-controller to actively convert AC power at an input of the voltage-source active rectifier to provide boosted and voltage -regulated DC power at an output of the at least one voltage-source active rectifier; at least one voltage sensor coupled to the output of the voltage-source active rectifier to provide a voltage signal to the rectifier-controller to enable the rectifier-controller to regulate the boosted and voltage -regulated DC power;
a plurality of bucking cell-stack-regulators (CSRs), wherein each of the bucking cell-stack-regulators includes a DC input and a DC output, wherein the DC input to each of the bucking cell stack regulators is coupled to the voltage-regulated output of the voltage-source active rectifier, and wherein each of the bucking cell-stack-regulators includes a CSR controller and at least one DC-to-DC-conversion-switch, wherein the CSR controller controls the at least one DC-to-DC-conversion-switch to provide regulated current to the DC output;
a plurality of dampers, wherein each of the dampers is disposed between the at least one voltage-source active rectifier and a corresponding one of the bucking cell-stack-regulators, each of the plurality of dampers including inductive, capacitive, and resistive elements to damp oscillations between the at least one voltage-source active rectifier and the corresponding one of the bucking cell-stack-regulators;
a plurality of current transducers, wherein each of the current transducers is disposed to sense current at a corresponding one of the DC outputs of the cell-stack-regulators, and each of the current transducers is coupled to a corresponding one of the CSR controllers to provide a signal indicative of the current at the corresponding one of the DC outputs;
a plurality of electrolysis cell stacks, wherein each of the electrolysis cell stacks is coupled to a corresponding one of the plurality of cell-stack regulators, and wherein each of the electrolysis cell stacks includes a plurality of electrolysis cells arranged in series; and
a coordinated controller that is coupled to the at least one voltage-source active rectifier and the plurality of bucking cell-stack-regulators, wherein the coordinated controller is configured to, in response to an event signal that indicates an event has affected the AC power, prompt the at least one voltage-source active rectifier to apply volt-ampere reactive (VAR) power to the input of the voltage-source active rectifier and trigger the plurality of bucking cell-stack-regulators to cease providing the regulated current to the plurality of electrolysis cell stacks.
